(19) United States
(12) Patent Application Publication
(10) Pub. No.: US 2018/0123942 A1
(43) Pub. Date: May 3, 2018

(54) ROUTE CONTROL APPARATUS AND ROUTE CONTROL METHOD

(71) Applicant: FUJITSU LIMITED, Kawasaki-shi (JP)

(72) Inventor: Kouichirou AMEMIYA, Kawasaki (JP)

(73) Assignee: FUJITSU LIMITED, Kawasaki-shi (JP)

(21) Appl. No.: 15/730,901

(22) Filed: Oct. 12, 2017

(30) Foreign Application Priority Data
Oct. 31, 2016 (JP) 2016-212591

(51) Int. Cl. H04L 12/751; H04L 12/707; H04L 12/721; H04L 12/803

(52) U.S. Cl. CPC H04L 45/02; H04L 47/122; H04L 45/38; H04L 45/22

(57) ABSTRACT

A route control apparatus includes a processor. The processor acquires a traffic volume of a path between each pair of nodes in a data transmission route formed utilizing a network. The processor determines based on the traffic volume whether the data transmission route is to be changed. The processor identifies first and second pairs of nodes based on the traffic volume and candidate information indicative of candidates for a pair of nodes to be connected. The processor transmits an addition request to the first pair of nodes to add a first path between the first pair of nodes to the data transmission route. The processor removes a second path between the second pair of nodes from the data transmission route by transmitting a change request to the first and second pairs of nodes to change a current connection relationship between each pair of nodes in the network.

### CROSS-REFERENCE TO RELATED APPLICATION

This application is based upon and claims the benefit of priority of the prior Japanese Patent Application No. 2016-212591, filed on Oct. 31, 2016, the entire contents of which are incorporated herein by reference.

### FIELD

The embodiment discussed herein is related to a route control apparatus and a route control method.

### BACKGROUND

There is a Subscribe/Publish system (Sub/Pub system) in which data (NOTIFY) is transmitted from a publisher to a subscriber utilizing an OVERLAY network that includes a plurality of brokers. If the communication burden on some broker of the plurality of brokers increases as a result of movement of a subscriber or a publisher, a data transmission route from a publisher to a subscriber may be changed after the connection relationship between each pair of brokers in the OVERLAY network is changed.

In related techniques, there is a technique in which, for example, when congestion occurs in an arbitrary interface, a rerouting path is set adaptively on basis of link state information retained synchronously by respective nodes and interface information managed locally by the respective nodes. Further, there is a technique in which, for example, the consumption amount of network resources on the current route and the consumption amount of network resources on a detour route are compared with each other and, when the difference between the consumption amounts is within an acceptable range, switching from the current route to the detour route is performed.

Related techniques are disclosed in, for example, Japanese Laid-open Patent Publication No. 2000-201182 and Japanese Laid-open Patent Publication No. 2002-9798.

When a connection relationship between each pair of brokers in the OVERLAY network is changed as described above, the data transmission route may be cut temporarily, and a time period appears within which data does not reach the subscriber from the publisher.

### SUMMARY

According to an aspect of the present invention, provided is a route control apparatus including a memory and a processor coupled to the memory. The processor is configured to acquire a traffic volume of a path between each pair of nodes in a data transmission route from a plurality of nodes. The data transmission route is formed utilizing a network including the plurality of nodes. The processor is configured to determine on the basis of the acquired traffic volume whether the data transmission route is to be changed. The processor is configured to identify, upon determining that the data transmission route is to be changed, a first pair of nodes and a second pair of nodes on the basis of the acquired traffic volume and candidate information. The first pair of nodes are to be newly connected to each other in the network. The second pair of nodes are to be disconnected from each other in the network. The candidate information is indicative of candidates for a pair of nodes to be connected to each other among the plurality of nodes. The processor is configured to transmit an addition request to at least one node of the first pair of nodes. The addition request requests to add a first path between the first pair of nodes to the data transmission route. The processor is configured to remove, after the first path is added, a second path between the second pair of nodes from the data transmission route by transmitting a change request to one node of the first pair of nodes and one node of the second pair of nodes. The change request requests to change a current connection relationship between each pair of nodes in the network.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a route control method according to an embodiment;

FIG. 2 is a diagram illustrating an example of a route control system;

FIG. 3 is a diagram illustrating an exemplary hardware configuration of a route control apparatus;

FIG. 4 is a diagram illustrating an exemplary hardware configuration of a node;

FIG. 5 is a diagram illustrating an example of information indicative of a traffic volume of a path between each pair of nodes;

FIG. 6 is a diagram illustrating an example of an issuance request for a TEMPORARY SUBSCRIBE;

FIG. 7 is a diagram illustrating an example of an activation/deactivation request;

FIG. 8 is a diagram illustrating an example of an OVERLAY connection request;

FIG. 9 is a diagram illustrating an example of an OVERLAY disconnection request;

FIG. 10 is a diagram illustrating an example of a storage content of a Sub/Pub table;

FIG. 11 is a diagram illustrating an example of a storage content of a redundancy removal table;

FIG. 12 is a diagram illustrating an example of data (NOTIFY) to be transmitted and received;

FIG. 13 is a diagram illustrating an example of a TEMPORARY SUBSCRIBE;

FIG. 14 is a diagram illustrating an example of a connection request for a link;

FIG. 15 is a diagram illustrating an example of an OVERLAY connection notification;

FIG. 16 is a diagram illustrating an example of a SUBSCRIBE;

FIG. 17 is a diagram illustrating an example of a disconnection request for a link;

FIG. 18 is a diagram illustrating an example of an OVERLAY disconnection notification;

FIG. 19 is a diagram illustrating an example of an UNSUBSCRIBE;

FIG. 20 is a diagram illustrating exemplary functional configurations of a route control apparatus and a node;

FIG. 21 is a diagram illustrating an example of operations of a route control apparatus and a node in the embodiment;

FIG. 22 is a diagram illustrating an example of generation of a minimum spanning tree;

FIG. 23 is a diagram illustrating an example of determination of a change sequence of a connection relationship between each pair of nodes in an OVERLAY network;

FIG. 24 is a diagram illustrating a particular example of components of a node illustrated in FIG. 21;

FIG. 25 is a diagram illustrating a state transition of a node;

FIG. 26 is a flowchart illustrating an example of a route control process;

FIG. 27 is a flowchart illustrating a TEMPORARY SUBSCRIBE issuance process;

FIG. 28 is a flowchart illustrating a TEMPORARY SUBSCRIBE reception process;

FIG. 29 is a flowchart illustrating a SUBSCRIBE reception process;

FIG. 30 is a flowchart illustrating an UNSUBSCRIBE reception process;

FIG. 31 is a flowchart illustrating a NOTIFY reception process;

FIG. 32 is a flowchart illustrating an OVERLAY disconnection process;

FIG. 33 is a flowchart illustrating an OVERLAY connection process;

FIG. 34 is a flowchart illustrating a NOTIFY disconnection process; and

FIG. 35 is a flowchart illustrating a NOTIFY connection process.

### DESCRIPTION OF EMBODIMENT

In the following, an embodiment is described in detail with reference to the drawings.

### Embodiment

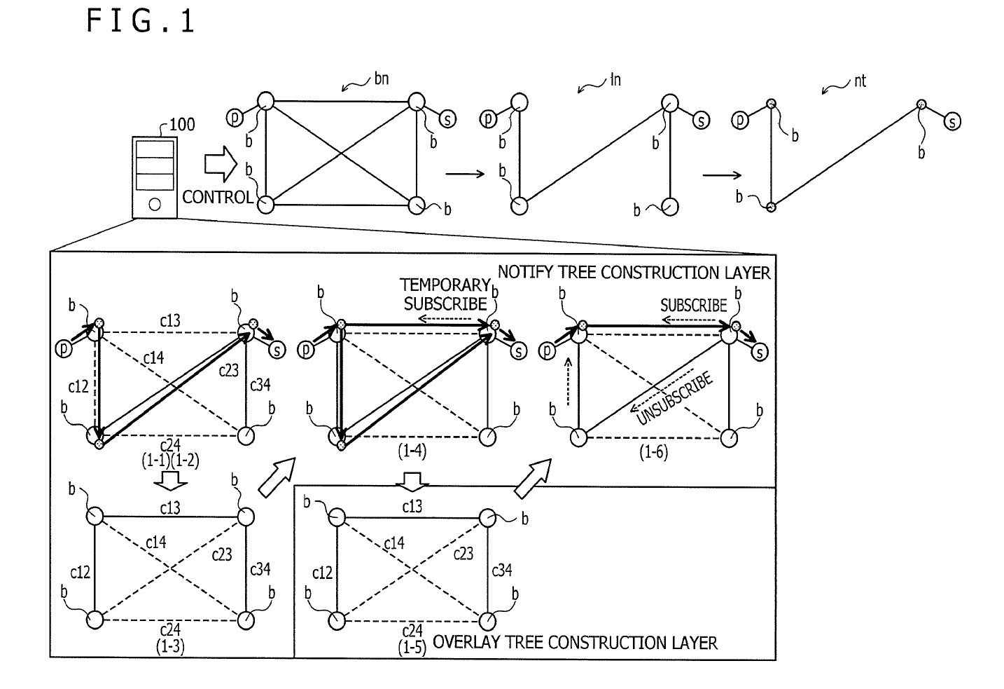

FIG. 1 is a diagram illustrating an example of a route control method according to an embodiment. The example of FIG. 1 includes a basic network bn and a route control apparatus 100. The basic network bn is a network including a publisher p, a subscriber s, and brokers b. The basic network bn may include a plurality of publishers p. The basic network bn may include a plurality of subscribers s. The basic network bn includes at least three brokers b.

The publisher p is a computer that transmits data. The data is, for example, a NOTIFY. The publisher p is, for example, a mobile terminal apparatus. The subscriber s is a computer that receives the data. The subscriber s is, for example, a mobile terminal apparatus. Each broker b is a computer that relays the data. The broker b is, for example, a node.

An OVERLAY network In is formed on the basic network bn. The OVERLAY network In is a network including publishers p, subscribers s, and brokers b. The OVERLAY network In is a virtual network utilizing at least part of the basic network bn.

The OVERLAY network In has, for example, a tree structure and is referred to as an OVERLAY tree. The OVERLAY network In does not include a loop. The OVERLAY network In is a network in a lower layer than that of the basic network bn. The layer to which the OVERLAY network In belongs is referred to as an OVERLAY tree construction layer.

A data transmission route nt is formed utilizing the OVERLAY network In. The data transmission route nt is a network including publishers p, subscribers s, and brokers b. The data transmission route nt is a virtual network utilizing at least part of the OVERLAY network In.

The data transmission route nt has, for example, a tree structure and is referred to as a NOTIFY tree. The data transmission route nt may be, for example, a route for coupling one publisher p and one subscriber s to each other, a route for coupling one publisher p and a plurality of subscribers s to each other, a route for coupling a plurality of publishers p and a plurality of subscribers s to each other, or the like. The data transmission route nt is a network in a layer lower than that of the OVERLAY network In. The layer to which the data transmission route nt belongs is referred to as a NOTIFY tree construction layer.

The data transmission route nt is a network for transmitting data from a publisher p to a subscriber s. In response to transmission of a SUBSCRIBE from the subscriber s to a broker b, the data transmission route nt is formed by transfer of the SUBSCRIBE by several brokers b. The SUBSCRIBE is information indicative of a type of data requested by the subscriber s.

The route control apparatus 100 is a computer capable of communicating with a plurality of brokers b included in the basic network bn. The route control apparatus 100 may control the connection relationship between each pair of brokers in the OVERLAY network In. The route control apparatus 100 may control the data transmission route nt independently of the OVERLAY network In.

When a subscriber s or a publisher p moves, the communication burden on some broker b may increase. For example, when a subscriber s or a publisher p moves, since a SUBSCRIBE or an UNSUBSCRIBE flows on the OVERLAY network In, the data transmission route nt is changed on the OVERLAY network In.

However, since the connection relationship between each pair of brokers in the OVERLAY network In is not changed, even when the data transmission route nt is changed, a route capable of efficiently transferring data therethrough is not formed and the communication burden on some broker b may increase.

When the communication burden on some broker b increases, the data transmission route nt utilizing the OVERLAY network In may be changed after the connection relationship between each pair of brokers in the OVERLAY network In is changed. For example, the data transmission route nt is changed through transfer of a SUBSCRIBE or an UNSUBSCRIBE by a plurality of brokers b utilizing the OVERLAY network In after the connection relationship between each pair of brokers in the OVERLAY network In is changed.

However, when the connection relationship between each pair of brokers in the OVERLAY network In is changed, a connection between a pair of brokers may be cut in the OVERLAY network In and the data transmission route nt is disconnected temporarily. This may give rise to a time period within which data does not reach the subscriber s from the publisher p. Further, in the course of change of the data transmission route nt, after part of the route is deleted from the data transmission route nt, the same route may be added to the data transmission route nt, and the data transmission route nt may be unable to be changed efficiently.

When a broker b is disconnected from another broker b in the OVERLAY network In, the data transmission route nt may be efficiently changed by transmitting an UNSUBSCRIBE to the other broker b after the broker b waits for a predetermined period of time. If the broker b newly receives a SUBSCRIBE from the other broker b while the broker b waits for the predetermined period of time, the broker b does not transmit an UNSUBSCRIBE.

However, when the connection relationship between each pair of brokers in the OVERLAY network In is changed, a connection between a pair of brokers may be cut in the OVERLAY network In and the data transmission route nt is disconnected temporarily. As a result, when the connection relationship between each pair of brokers in the OVERLAY network In is changed, data may be unable to reach the subscriber s from the publisher p.

Thus, when the data transmission route nt is changed on the OVERLAY network In after the connection relationship between each pair of brokers in the OVERLAY network In is changed, a period may appear within which data does not reach the subscriber s from the publisher p.

Therefore, in the description of the present embodiment, a route control method is described in which, a temporary path is newly added to the data transmission route nt utilizing the basic network bn before the connection relationship between each pair of brokers in the OVERLAY network In is changed. According to the route control method, even when the connection relationship between each pair of brokers in the OVERLAY network In is changed, the period within which data does not reach the subscriber s from the publisher p does not appear.

In the example of FIG. 1, (1-1) the route control apparatus 100 acquires a traffic volume of a path between each pair of nodes in the data transmission route nt from a plurality of nodes. For example, each node measures the amount of data transmitted from the own node to each of other nodes that are directly communicable with the own node for every predetermined period, and transmits a result of the measurement to the route control apparatus 100. The route control apparatus 100 receives, from the nodes, the results of the measurement performed by the nodes.

(1-2) The route control apparatus 100 determines whether or not the data transmission route nt is to be changed, based on the acquired traffic volume of a path between each pair of nodes in the data transmission route nt. The route control apparatus 100 calculates a traffic volume of a path between each pair of nodes in the OVERLAY network In as costs c12 to c34 for the respective pairs of nodes, for example, based on the traffic volume of a path between each pair of nodes in the current data transmission route nt. Then, the route control apparatus 100 determines, based on the costs c12 to c34 for the respective pairs of nodes, whether or not the data transmission route nt is to be changed.

For example, the route control apparatus 100 calculates, based on the costs c12 to c34 for the respective pairs of nodes, the sum of the traffic volume of a path between each pair of nodes assuming that the connection relationship between each pair of nodes in the OVERLAY network In is changed. The route control apparatus 100 subtracts the sum of the traffic volume of a path between each pair of nodes calculated assuming that the connection relationship between each pair of nodes in the OVERLAY network In is changed, from the sum of the traffic volume of a path between each pair of nodes in the current data transmission route nt, to calculate the difference between the sums. When the calculated difference is equal to or greater than a predetermined threshold value, the route control apparatus 100 determines that the data transmission route nt is to be changed.

(1-3) When it is determined that the data transmission route nt is to be changed, the route control apparatus 100 acquires information indicative of candidates for a pair of nodes to be connected to each other among the plurality of nodes. The information is, for example, topology information indicative of candidates for the connection relationship between each pair of nodes which may be changed in the OVERLAY network In. The information may be, for example, information indicative of each pair of nodes that may be connected to each other in the OVERLAY network In. The route control apparatus 100 identifies, based on the acquired information and the acquired traffic volume of a path between each pair of nodes, pairs of nodes to be newly connected to each other and pairs of nodes to be disconnected from each other in the OVERLAY network In.

The route control apparatus 100 identifies a candidate for the connection relationship between each pair of nodes in the OVERLAY network In with which the sum of the traffic volume of a path between each pair of nodes in the OVERLAY network In is minimized, based on the acquired traffic volume of a path between each pair of nodes. Then, the route control apparatus 100 identifies, based on the identified candidate, pairs of nodes to be newly connected to each other and pairs of nodes to be disconnected from each other in the OVERLAY network In.

(1-4) Based on information on the identified pairs of nodes to be newly connected to each other, the route control apparatus 100 transmits, to each of the pairs of nodes to be newly connected to each other, an addition request for adding a temporary path for linking the pair of nodes to be newly connected to each other to the data transmission route nt. The route control apparatus 100 adds a temporary path that links the pair of nodes to be newly connected to each other to the data transmission route nt, for example, such that data may flow along the temporary path that links the pair of nodes to be newly connected to each other even though the connection relationship between each pair of nodes in the OVERLAY network In is not changed. For example, the route control apparatus 100 controls the pair of nodes to be newly connected to each other such that the pair of nodes to be newly connected to each other transmit a TEMPORARY SUBSCRIBE to each other through the basic network bn to add the temporary path, which links the pair of nodes to be newly connected to each other, to the data transmission route nt. The TEMPORARY SUBSCRIBE is, similar to the SUBSCRIBE, information indicative of a type of data requested by the subscriber s.

The pair of nodes to be newly connected to each other receive the addition request and transmit a TEMPORARY SUBSCRIBE to each other to add the temporary path, which links the pair of nodes to be newly connected to each other, to the data transmission route nt. After the temporary path is added to the data transmission route nt, the pair of nodes to be newly connected to each other transmit data using the original data transmission route nt and the added temporary path.

(1-5) After the temporary path is added to the data transmission route nt, based on the information on the pair of nodes to be newly connected to each other, the route control apparatus 100 transmits a change request for changing the connection relationship between each pair of nodes in the OVERLAY network In to the pair of nodes to be newly connected to each other. Further, after the temporary path is added to the data transmission route nt, based on information on the pair of nodes to be disconnected from each other, the route control apparatus 100 transmits a change request for changing the connection relationship between each pair of nodes in the OVERLAY network In to the pair of nodes to be disconnected from each other. The route control apparatus 100 controls, for example, the pair of nodes to be newly connected to each other such that the pair of nodes to be newly connected to each other are connected to each other in the OVERLAY network In. Also, the route control apparatus 100 controls, for example, the pair of nodes to be disconnected from each other such that the pair of nodes to be disconnected from each other are disconnected from each other in the OVERLAY network In.

(1-6) Upon receiving the change request, the node adds, in response to the connection of the pair of nodes to be newly connected to each other, a path that links the relevant pair of nodes to the data transmission route nt. Further, upon receiving the change request, the node removes, in response to the disconnection of the pair of nodes to be disconnected from each other, the path that links the relevant pair of nodes to each other from the data transmission route nt.

The nodes to be newly connected to each other transmit, for example, a SUBSCRIBE to add a path that links the relevant pair of nodes to the data transmission route nt. The nodes to be disconnected from each other transmit an UNSUBSCRIBE to remove the path that links the relevant pair of nodes from the data transmission route nt.

Consequently, even while the connection relationship between each pair of nodes in the OVERLAY network In is being changed, since the temporary path is added to the data transmission route nt, the route control apparatus 100 may avoid the data transmission route nt from being disconnected. Therefore, the route control apparatus 100 may avoid appearance of a period within which data does not reach the subscriber s from the publisher p during changing of the connection relationship between each pair of nodes in the OVERLAY network In.

While the case is described here in which each node transmits to the route control apparatus 100 for every predetermined period, a result of measurement of an amount of data transmitted from the own node to each of the other nodes with which the own node is directly communicable, the embodiment is not limited to this. For example, each node may measure an amount of data transmitted from the own node to each of the other nodes, with which the own node is directly communicable for every predetermined period and transmit a result of the measurement to the route control apparatus 100 when the result of the measurement satisfies a predetermined condition.

While the case is described here in which the route control apparatus 100 determines that the data transmission route nt is to be changed when the calculated difference is equal to or greater than the threshold value, the embodiment is not limited to this. For example, the route control apparatus 100 may determine that the data transmission route nt is to be changed when the sum of the traffic volume of a path between each pair of nodes is to be equal to or greater than a threshold value if the connection relationship between each pair of nodes in the OVERLAY network In is changed. Alternatively, the route control apparatus 100 may determine that the data transmission route nt is to be changed when the maximum value of the traffic volume of a path between each pair of nodes is equal to or greater than a threshold value in a case of the change in the connection relationship between each pair of nodes in the OVERLAY network In, for example.

While the case is described here in which the route control apparatus 100 identifies a candidate for the connection relationship between each pair of nodes in the OVERLAY network In, based on a plurality of pieces of predetermined topology information, the embodiment is not limited to this. For example, the route control apparatus 100 may identify a candidate for the connection relationship between each pair of nodes in the OVERLAY network In, based on information indicative of each pair of nodes that may be connected to each other, using a heuristic solution method such that the sum of the traffic volume of a path between each pair of nodes becomes comparatively small.

While the case is described here in which, after a SUBSCRIBE is transmitted in response to an addition request, the pair of nodes to be newly connected to each other transmit data using the original data transmission route nt and the added temporary path, the embodiment is not limited to this. For example, after a SUBSCRIBE is transmitted in response to an addition request, the pair of nodes to be newly connected to each other may transmit data using the added temporary path instead of using the original data transmission route nt.

While the case is described here in which, in response to adding the temporary path connecting the pair of nodes to be newly connected to each other in the OVERLAY network In, the nodes add a path that links the pair of nodes to each other to the data transmission route nt, the embodiment is not limited to this. For example, since the temporary path added in response to an addition request is available, the nodes does not need to add a path that links the pair of nodes to each other to the data transmission route nt in response to adding the temporary path connecting the pair of nodes to be newly connected to each other in the OVERLAY network In.

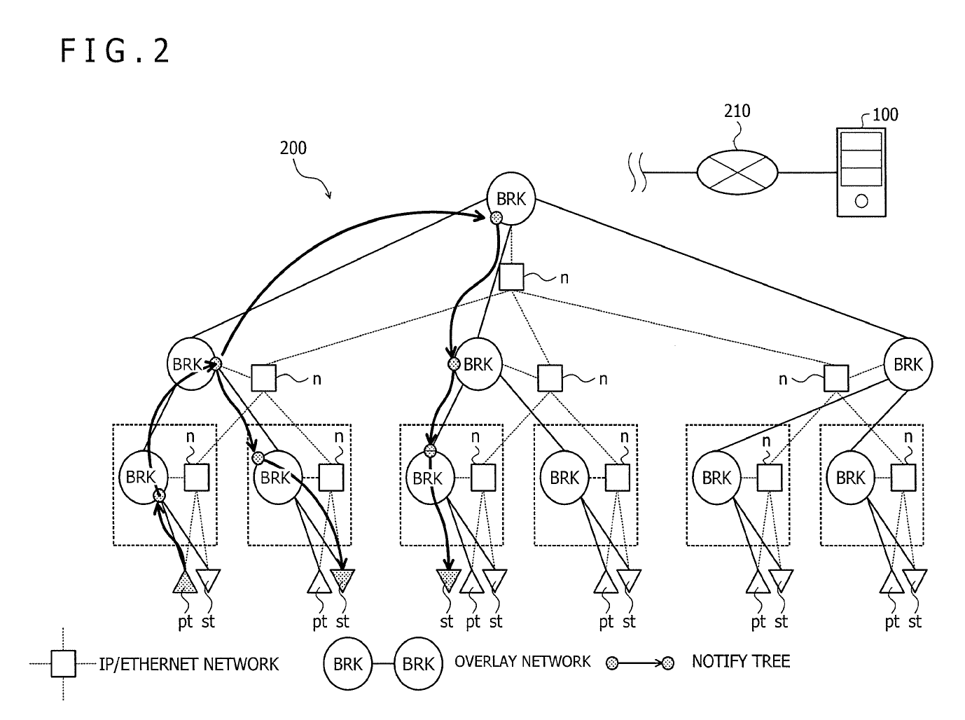

Now, an example of a route control system 200 to which the route control apparatus 100 illustrated in FIG. 1 is applied is described with reference to FIG. 2.

FIG. 2 is a diagram illustrating an example of the route control system 200. As illustrated in FIG. 2, the route control system 200 includes the route control apparatus 100, a plurality of transmission terminals pt each serving as a publisher p, a plurality of reception terminals st each serving as a subscriber s, and a plurality of nodes n each serving as a broker b.

In the route control system 200, the route control apparatus 100 is coupled to the respective nodes n through a wired or wireless network 210. The network 210 is, for example, a local area network (LAN), a wide area network (WAN), the Internet, or the like.

The plurality of transmission terminals pt, the plurality of reception terminals st, and the plurality of nodes n are coupled to each other to form a basic network bn that includes the plurality of transmission terminals pt, the plurality of reception terminals st, and the plurality of nodes n. The basic network bn is an internet protocol (IP) network or an Ethernet network. Ethernet is a registered trademark. On the basic network bn, an OVERLAY network In is formed which includes the plurality of transmission terminals pt, the plurality of reception terminals st, and the plurality of nodes n. The OVERLAY network In has, for example, a tree structure and is called an OVERLAY tree.

Further, on the OVERLAY network In, a data transmission route nt is formed which includes the plurality of transmission terminals pt, the plurality of reception terminals st, and the plurality of nodes n. The data transmission route nt may include a path that links a pair of nodes, which are not connected to each other in the OVERLAY network In, to each other as a temporary path. The data transmission route nt has, for example, a tree structure and is called a NOTIFY tree.

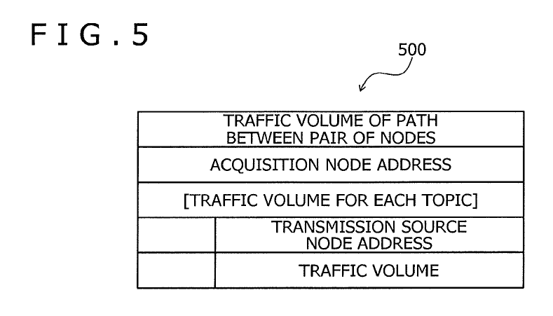

The route control apparatus 100 may communicate with the plurality of nodes n included in the basic network bn. The route control apparatus 100 may acquire information 500 indicative of a traffic volume of a path between each pair of nodes in the data transmission route nt from the plurality of nodes n and store the information 500 therein. An example of the information 500 indicative of the traffic volume of a path between each pair of nodes is described later with reference to FIG. 5.

The route control apparatus 100 may store therein information indicative of candidates for a pair of nodes to be connected to each other among the plurality of nodes n. The route control apparatus 100 may store therein, for example, topology information indicative of candidates for the connection relationship between each pair of nodes which may be changed in the OVERLAY network In. The route control apparatus 100 may store therein, for example, information indicative of each pair of nodes that may be connected to each other in the OVERLAY network In.

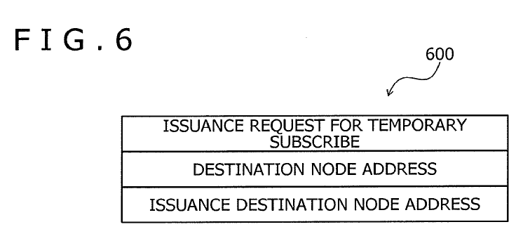

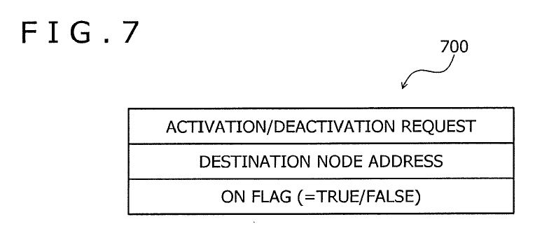

The route control apparatus 100 may transmit, to each of the nodes n, an issuance request 600 for a TEMPORARY SUBSCRIBE to cause each node n to issue a TEMPORARY SUBSCRIBE through a port directed toward a transmission terminal pt. An example of the issuance request 600 for a TEMPORARY SUBSCRIBE is described later with reference to FIG. 6. After the route control apparatus 100 transmits the issuance request 600 for a TEMPORARY SUBSCRIBE, the route control apparatus 100 may transmit an activation request 700 to each of the nodes n to cause the node n to activate a redundancy removal process in which the node n discards duplicative pieces of received data having an identical content while leaving one piece thereof. An example of the activation request 700 is described later with reference to FIG. 7.

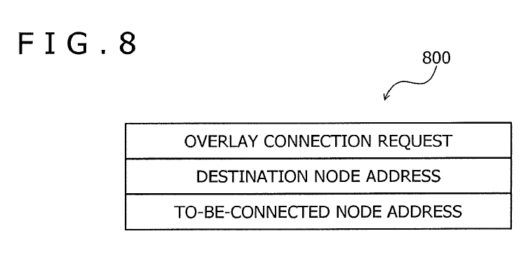

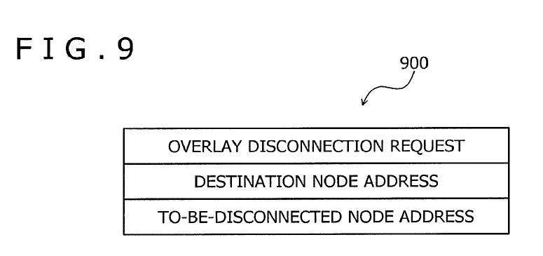

The route control apparatus 100 may transmit a change request to each of the nodes n to change the connection relationship between each pair of nodes in the OVERLAY network In to each of the nodes n. The change request is, for example, an OVERLAY connection request 800 for connecting a pair of nodes to each other in the OVERLAY network In or an OVERLAY disconnection request 900 for disconnecting a pair of nodes from each other in the OVERLAY network In. For example, the route control apparatus 100 may transmit, to each of the nodes n, an OVERLAY connection request 800 for connecting a pair of nodes in the OVERLAY network In to each other. An example of the OVERLAY connection request 800 is described later with reference to FIG. 8. The route control apparatus 100 may transmit, to each of the nodes n, an OVERLAY disconnection request 900 for disconnecting a pair of nodes from each other in the OVERLAY network In. An example of the OVERLAY disconnection request 900 is described later with reference to FIG. 9.

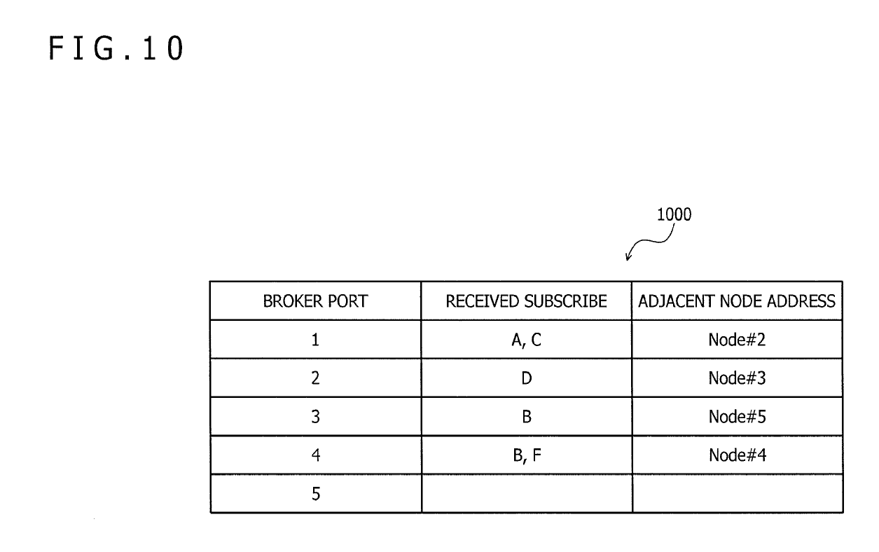

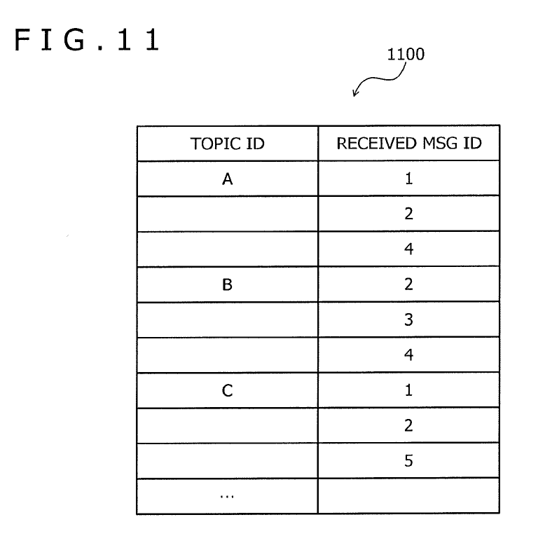

Each node n includes ports to be connected to other nodes n. Each node n may store therein a Sub/Pub table 1000 that is used to control which node n is to be connected to which port and which topic data is to be transmitted to which port. An example of the storage content of the Sub/Pub table 1000 is described later with reference to FIG. 10. Each node n may store therein a redundancy removal table 1100 that is used to manage received data. An example of the storage content of the redundancy removal table 1100 is described later with reference to FIG. 11.

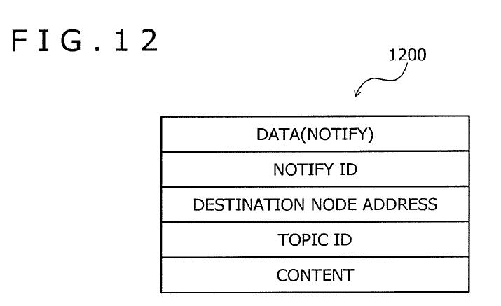

Each node n may receive data 1200 from another node n through a port of the own node n and may transmit the data 1200 to another node n through a port of the own node n. An example of the data 1200 to be transmitted and received is described later with reference to FIG. 12. Each node n may measure the traffic volume of a path which connects the own node n to each of other nodes n directly communicable with the own node n in the data transmission route nt and transmit information indicative of the measured traffic volume to the route control apparatus 100. An example of information indicative of the measured traffic volume is described later with reference to FIG. 5.

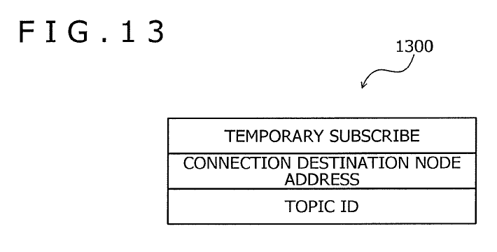

Upon receiving an issuance request 600 for a TEMPORARY SUBSCRIBE 1300 from the route control apparatus 100, each node n may issue a TEMPORARY SUBSCRIBE 1300 through a port directed toward the transmission terminal pt among the ports of the own node n. An example of the TEMPORARY SUBSCRIBE 1300 is described later with reference to FIG. 13. Upon receiving an activation request 700 for a redundancy removal process from the route control apparatus 100, each node n may activate the redundancy removal process to discard duplicative pieces of received data 1200 having an identical content while leaving one piece thereof.

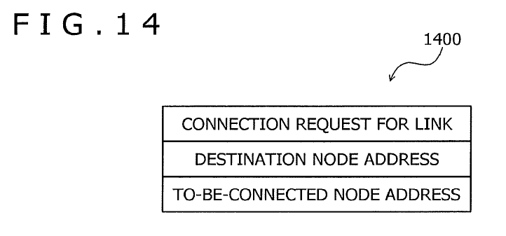

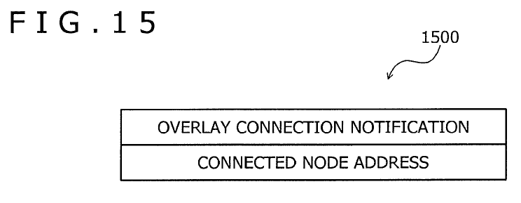

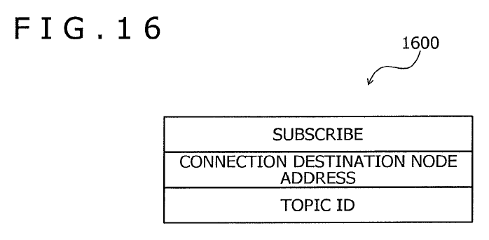

Upon receiving a change request, each node n changes the connection relationship between each pair of nodes in the OVERLAY network In. For example, upon receiving an OVERLAY connection request 800, each node n transmits a connection request 1400 for a link in the OVERLAY network In to another node n to establish a link to the other node n. An example of the connection request 1400 is described later with reference to FIG. 14. Upon establishing the link to the other node n, the node n outputs an OVERLAY connection notification 1500. An example of the OVERLAY connection notification 1500 is described later with reference to FIG. 15. Upon detecting that the OVERLAY connection notification 1500 is outputted, the node n may issue a SUBSCRIBE 1600 to the other node n. An example of the SUBSCRIBE 1600 is described later with reference to FIG. 16.

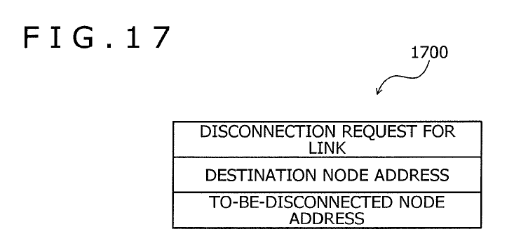

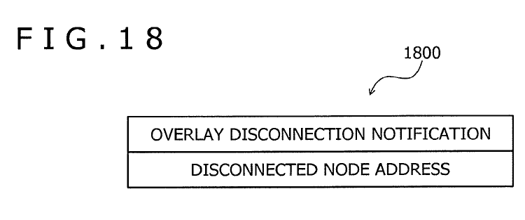

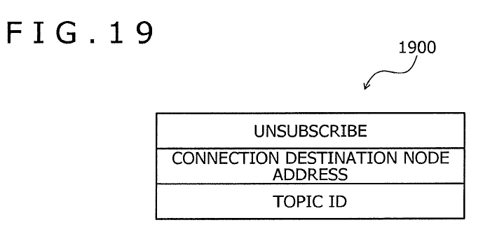

For example, upon receiving an OVERLAY disconnection request 900, each node n transmits a disconnection request 1700 for a link in the OVERLAY network In to another node n to cut the link to the other node n. An example of the disconnection request 1700 for a link is described later with reference to FIG. 17. Upon cutting the link to the other node n, the node n outputs an OVERLAY disconnection notification 1800. An example of the OVERLAY disconnection notification 1800 is described later with reference to FIG. 18. Upon detecting that the OVERLAY disconnection notification 1800 is outputted, the node n may issue an UNSUBSCRIBE 1900 to the other node n. An example of the UNSUBSCRIBE 1900 is described later with reference to FIG. 19.

The route control system 200 illustrated in FIG. 2 may be applied, for example, to a system for collecting sensing data from sensors and the like. In this case, for example, the transmission terminals pt are the sensors and the like. For example, each of the reception terminals st registers a topic, which is information indicative of sensing data that satisfies a predetermined condition, into a node n and receives sensing data that satisfies the predetermined condition. Further, the route control system 200 illustrated in FIG. 2 may be applied also to a system that collects, for example, driving information from automotive apparatuses. In this case, for example, the transmission terminals pt and the reception terminals st are the automotive apparatuses.

Although a case is described here in which a terminal apparatus that serves as the publisher p and a terminal apparatus that serves as the subscriber s are apparatuses separate from each other, the embodiment is not limited to this. For example, a terminal apparatus that serves as the publisher p and a terminal apparatus that serves as the subscriber s may be the same apparatus.

Although a case is described here in which the route control apparatus 100 is an apparatus different from the transmission terminals pt, the reception terminals st, and the nodes n, the embodiment is not limited to this. For example, the route control apparatus 100 may be integrated with one of the transmission terminals pt. Alternatively, for example, the route control apparatus 100 may be integrated with one of the reception terminals st. Alternatively, for example, the route control apparatus 100 may be integrated with one of the nodes n.

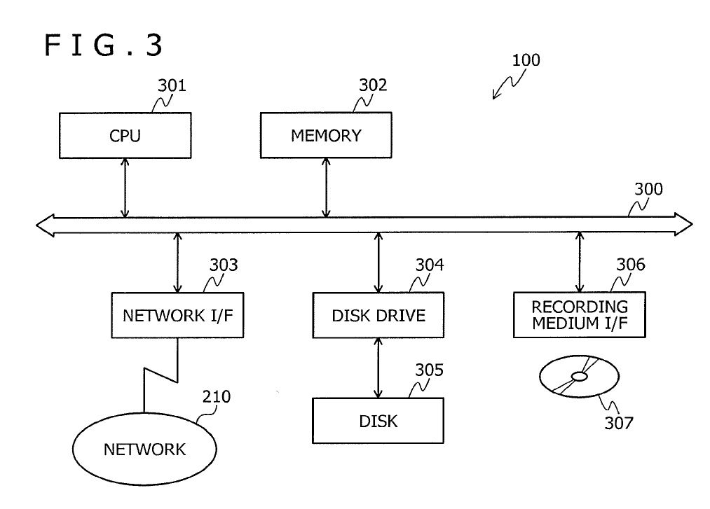

Now, an exemplary hardware configuration of the route control apparatus 100 included in the route control system 200 illustrated in FIG. 2 is described with reference to FIG. 3.

FIG. 3 is a diagram illustrating an exemplary hardware configuration of the route control apparatus 100. As illustrated in FIG. 3, the route control apparatus 100 includes a central processing unit (CPU) 301, a memory 302, a network interface (I/F) 303, a disk drive 304, a disk 305, and a recording medium I/F 306. These components are coupled to each other by a bus 300.

The CPU 301 is responsible for control of the entire route control apparatus 100. The memory 302 includes, for example, a read-only memory (ROM), a random access memory (RAM), a flash ROM, and the like. For example, the flash ROM or the ROM has various programs stored therein, and the RAM is used as a work area of the CPU 301. The programs stored in the memory 302 are loaded into the CPU 301 to allow the CPU 301 to execute processes encoded therein.

The network I/F 303 is coupled to the network 210 through a communication line and is coupled to other computers (for example, a node n illustrated in FIG. 2) through the network 210. The network I/F 303 is responsible for interfacing between the network 210 and the inside of the route control apparatus 100 and controls inputting/outputting of data from and to the other computers. As the network I/F 303, for example, a modem or a LAN adapter may be adopted.

The disk drive 304 controls reading/writing of data from/to the disk 305 under the control of the CPU 301. The disk drive 304 is, for example, a magnetic disk drive. The disk 305 is a nonvolatile memory that stores data written therein under the control of the disk drive 304. The disk 305 is, for example, a magnetic disk, an optical disk, or the like.

The recording medium I/F 306 is coupled to an external recording medium 307, is responsible for interfacing between the external recording medium 307 and the inside of the route control apparatus 100, and controls inputting/outputting of data from/to the external recording medium 307. The recording medium I/F 306 is, for example, a universal serial bus (USB) port. The recording medium 307 is, for example, a USB memory. The recording medium 307 may store therein a route control program according the embodiment.

The route control apparatus 100 may include, for example, a solid state drive (SSD), a semiconductor memory, a keyboard, a mouse, a display unit, and the like in addition to the components described above. The route control apparatus 100 may include an SSD, a semiconductor memory, or the like in place of the disk drive 304 and the disk 305.

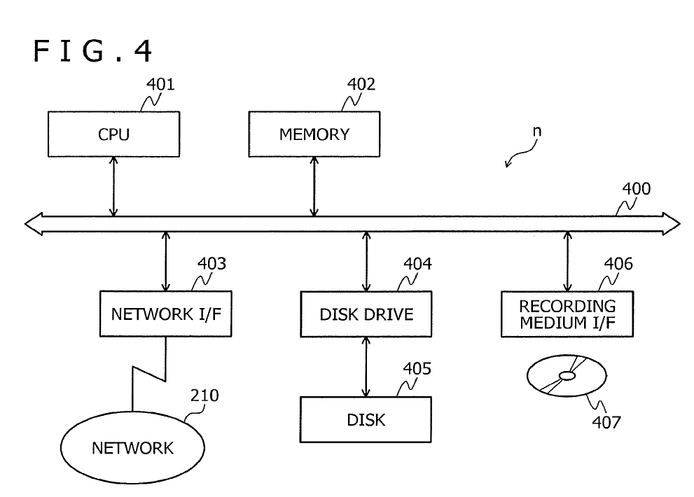

Now, an exemplary hardware configuration of each node n included in the route control system 200 illustrated in FIG. 2 is described with reference to FIG. 4.

FIG. 4 is a diagram illustrating an exemplary hardware configuration of each node n. As illustrated in FIG. 4, each node n includes a CPU 401, a memory 402, a network I/F 403, a disk drive 404, a disk 405, and a recording medium I/F 406. These components are coupled to each other by a bus 400.

The CPU 401 is responsible for control of the entire node n. The memory 402 includes, for example, a ROM, a RAM, a flash ROM, and the like. For example, the flash ROM or the ROM has various programs stored therein, and the RAM is used as a work area of the CPU 401. The programs stored in the memory 402 are loaded into the CPU 401 to allow the CPU 401 to execute processes encoded therein.

The network I/F 403 is coupled to the network 210 through a communication line and is coupled to other computers (for example, the route control apparatus 100 illustrated in FIG. 2) through the network 210. The network I/F 403 is responsible for interfacing between the network 210 and the inside of the node n and controls inputting/outputting of data from and to the other computers. As the network I/F 403, for example, a modem or a LAN adapter may be adopted.

The disk drive 404 controls reading/writing of data from/to the disk 405 under the control of the CPU 401. The disk drive 404 is, for example, a magnetic disk drive. The disk 405 is a nonvolatile memory that stores data written therein under the control of the disk drive 404. The disk 405 is, for example, a magnetic disk, an optical disk, or the like.

The recording medium I/F 406 is coupled to an external recording medium 407, is responsible for interfacing between the external recording medium 407 and the inside of the node n, and controls inputting/outputting of data from/to the external recording medium 407. The recording medium I/F 406 is, for example, a USB port. The recording medium 407 is, for example, a USB memory. The recording medium 407 may store therein the route control program according the embodiment.

The node n may include, for example, an SSD, a semiconductor memory, a keyboard, a mouse, a display unit, and the like in addition to the components described above. The node n may include an SSD, a semiconductor memory, or the like in place of the disk drive 404 and the disk 405.

Now, an example of the information 500 indicative of a traffic volume of a path between each pair of nodes is described with reference to FIG. 5.

FIG. 5 is a diagram illustrating an example of the information 500 indicative of a traffic volume of a path between each pair of nodes. The information 500 indicative of a traffic volume of a path between each pair of nodes has fields for “acquisition node address”, “transmission source node address” for each topic, and “traffic volume” for each topic.

In the field for “acquisition node address”, an address of a node n which measures the traffic volume is set. In the field for “transmission source node address”, an address of the node n serving as a transmission source of the data 1200 belonging to the topic is set. In the field for “traffic volume”, the traffic volume of the data 1200 belonging to the topic is set.

Now, an example of the issuance request 600 for a TEMPORARY SUBSCRIBE 1300 is described with reference to FIG. 6.

FIG. 6 is a diagram illustrating an example of the issuance request 600 for a TEMPORARY SUBSCRIBE 1300. The issuance request 600 for a TEMPORARY SUBSCRIBE 1300 has fields for “destination node address” and “issuance destination node address”.

In the field for “destination node address”, an address of a node n that is a destination of the issuance request 600 for a TEMPORARY SUBSCRIBE 1300 is set. In the field for “issuance destination node address”, an address of a node n that is a destination of the TEMPORARY SUBSCRIBE 1300 is set.

Now, an example of an activation/deactivation request is described with reference to FIG. 7.

FIG. 7 is a diagram illustrating an example of the activation/deactivation request. The activation/deactivation request has fields for “destination node address” and “ON flag”.

In the field for “destination node address”, an address of a node n that is a destination of the activation/deactivation request is set. In the field for “ON flag”, a flag indicative of whether a redundancy removal process is to be activated or deactivated is set. “TRUE” indicates that the redundancy removal process is to be activated. “FALSE” indicates that the redundancy removal process is to be deactivated.

Now, an example of the OVERLAY connection request 800 is described with reference to FIG. 8.

FIG. 8 is a diagram illustrating an example of the OVERLAY connection request 800. The OVERLAY connection request 800 has fields for “destination node address” and “to-be-connected node address”.

In the field for “destination node address”, an address of a node n that is a destination of the OVERLAY connection request 800 is set. The node n is one node of a pair of nodes between which a link is added by the connection request 1400 for a link. In the field for “to-be-connected node address”, an address of a node n, which is the other node of the pair, is set.

Now, an example of the OVERLAY disconnection request 900 is described with reference to FIG. 9.

FIG. 9 is a diagram illustrating an example of the OVERLAY disconnection request 900. The OVERLAY disconnection request 900 has fields for “destination node address” and “to-be-disconnected node address”.

In the field for “destination node address”, an address of a node n that is a destination of the OVERLAY disconnection request 900 is set. The node n is one node of a pair of nodes between which a link is to be cut by the disconnection request 1700 for a link. In the field for “to-be-disconnected node address”, an address of a node n, which is the other node of the pair, is set.

Now, an example of the storage content of the Sub/Pub table 1000 is described with reference to FIG. 10. The Sub/Pub table 1000 is implemented, for example, by a storage area of the memory 402 or the disk 405 illustrated in FIG. 4.

FIG. 10 is a diagram illustrating an example of the storage content of the Sub/Pub table 1000. The Sub/Pub table 1000 has fields for “broker port”, “received SUBSCRIBE”, and “adjacent node address”. In the Sub/Pub table 1000, connection information of a data transmission route nt is stored as a record by setting information to the fields for each port of the node n.

In the field for “broker port” of each record, the number of the port of the node n is set. In the field for “received SUBSCRIBE”, a topic identification (ID) of a topic of the data 1200 to be transmitted through the port is set. In the field for “adjacent node address”, an address of a node n connected through the port is set.

Now, an example of the storage content of the redundancy removal table 1100 is described with reference to FIG. 11. The redundancy removal table 1100 is implemented, for example, by a storage area of the memory 402 or the disk 405 illustrated in FIG. 4.

FIG. 11 is a diagram illustrating an example of the storage content of the redundancy removal table 1100. The redundancy removal table 1100 has fields for “topic ID” and “received MSG ID”. In the redundancy removal table 1100, information for managing received data 1200 is stored as a record by setting information to the fields for each of the received data 1200.

In the field for “topic ID”, a topic ID of a topic to which the received data 1200 belongs is set. In the field for “received MSG ID”, a NOTIFY ID for identifying the received data 1200 is set.

Now, an example of the data 1200 to be transmitted and received is described with reference to FIG. 12.

FIG. 12 is a diagram illustrating an example of the data 1200 to be transmitted and received. The data 1200 to be transmitted and received has fields for “NOTIFY ID”, “destination node address”, “topic ID”, and “content”.

In the field for “NOTIFY ID”, a NOTIFY ID for identifying the data 1200 is set. In the field for “destination node address”, an address of a node n that is a destination of the data 1200 is set. In the field for “topic ID”, a topic ID of the topic to which the data 1200 belongs is set. In the field for “content”, the content of the data 1200 is set.

Now, an example of the TEMPORARY SUBSCRIBE 1300 is described with reference to FIG. 13.

FIG. 13 is a diagram illustrating an example of the TEMPORARY SUBSCRIBE 1300. The TEMPORARY SUBSCRIBE 1300 has fields for “connection destination node address” and “topic ID”.

In the field for “connection destination node address”, an address of a node n that transmits the TEMPORARY SUBSCRIBE 1300 is set. In the field for “topic ID”, a topic ID of a topic to which the data 1200 requested to be transmitted from the node n (destination of the TEMPORARY SUBSCRIBE 1300) to a node n (transmission source of the TEMPORARY SUBSCRIBE 1300) belongs is set.

Now, an example of the connection request 1400 for a link is described with reference to FIG. 14.

FIG. 14 is a diagram illustrating an example of the connection request 1400 for a link. The connection request 1400 for a link has fields for “destination node address” and “to-be-connected node address”.

In the field for “destination node address”, an address of a node n that is a destination of the connection request 1400 for a link is set. In the field for “to-be-connected node address”, an address of the own node n to be connected to the node n that serves as the destination of the connection request 1400 for a link is set.

Now, an example of the OVERLAY connection notification 1500 is described with reference to FIG. 15.

FIG. 15 is a diagram illustrating an example of the OVERLAY connection notification 1500. The OVERLAY connection notification 1500 has a field for “connected node address”.

In the field for “connected node address”, an address of another node n connected to the own node n in the OVERLAY network In is set.

Now, an example of the SUBSCRIBE 1600 is described with reference to FIG. 16.

FIG. 16 is a diagram illustrating an example of the SUBSCRIBE 1600. The SUBSCRIBE 1600 has fields for “connection destination node address” and “topic ID”.

In the field for “connection destination node address”, an address of a node n that transmits the SUBSCRIBE 1600 is set. In the field for “topic ID”, a topic ID of a topic to which the data 1200 requested to be transmitted from the node n (destination of the SUBSCRIBE 1600) to a node n (transmission source of the SUBSCRIBE 1600) belongs is set.

Now, an example of the disconnection request 1700 for a link is described with reference to FIG. 17.

FIG. 17 is a diagram illustrating an example of the disconnection request 1700 for a link. The disconnection request 1700 for a link has fields for “destination node address” and “to-be-disconnected node address”.

In the field for “destination node address”, an address of a node n that is a destination of the disconnection request 1700 for a link is set. In the field for “to-be-disconnected node address”, an address of the own node n to be disconnected from the node n that is the destination of the disconnection request 1700 for a link is set.

Now, an example of the OVERLAY disconnection notification 1800 is described with reference to FIG. 18.

FIG. 18 is a diagram illustrating an example of the OVERLAY disconnection notification 1800. The OVERLAY disconnection notification 1800 has a field for “disconnected node address”.

In the field for “disconnected node address”, an address of another node n disconnected from the own node n in the OVERLAY network In is set.

Now, an example of the UNSUBSCRIBE 1900 is described with reference to FIG. 19.

FIG. 19 is a diagram illustrating an example of the UNSUBSCRIBE 1900. The UNSUBSCRIBE 1900 has fields for “connection destination node address” and “topic ID”.

In the field for “connection destination node address”, an address of a node n that transmits the UNSUBSCRIBE 1900 is set. In the field for “topic ID”, a topic ID of a topic to which the data 1200 to be stopped to be transmitted from the node n (destination of the UNSUBSCRIBE 1900) to a node n (transmission source of the UNSUBSCRIBE 1900) belongs is set.

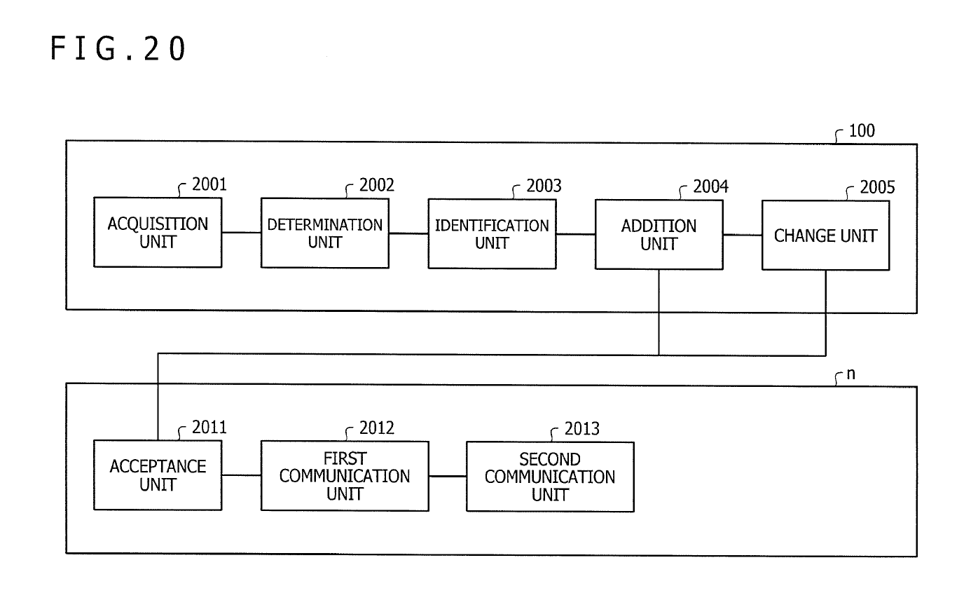

Now, exemplary functional configurations of the route control apparatus 100 and a node n is described with reference to FIG. 20.

FIG. 20 is a diagram illustrating exemplary functional configurations of the route control apparatus 100 and a node n. The route control apparatus 100 includes an acquisition unit 2001, a determination unit 2002, an identification unit 2003, an addition unit 2004, and a change unit 2005. Functions of the acquisition unit 2001 to the change unit 2005 are implemented by causing the CPU 301 to execute programs stored in a storage area, for example, of the memory 302 or the disk 305 illustrated in FIG. 3 or by the network I/F 303. Processing results of the respective function units are stored in the storage area, for example, of the memory 302 or the disk 305 illustrated in FIG. 3.

The acquisition unit 2001 acquires a traffic volume of a path between each pair of nodes in the data transmission route nt on the OVERLAY network In including a plurality of nodes n, from the plurality of nodes n. The data transmission route nt is, for example, a NOTIFY tree. The acquisition unit 2001 receives, for example, a traffic volume of the data 1200 for each topic received by each of a plurality of nodes n through the respective ports of each node n.

Consequently, the acquisition unit 2001 may acquire information to be used to evaluate whether or not data 1200 is transferred efficiently by the data transmission route nt and to determine whether or not the data transmission route nt is to be changed.

The acquisition unit 2001 may acquire the traffic volume of a path between each pair of nodes in the data transmission route nt on the OVERLAY network In including a plurality of nodes n, from the plurality of nodes n at each of a plurality of points of time. The acquisition unit 2001 receives, for example, at each of the plurality of points of time, a traffic volume of the data 1200 for each topic received by each of the plurality of nodes n through the respective ports of each node n.

Consequently, the acquisition unit 2001 may acquire information to be used to evaluate whether or not data 1200 is transferred efficiently by the data transmission route nt and to determine whether or not the data transmission route nt is to be changed.

The acquisition unit 2001 acquires, from some node n, a notification indicating that a difference calculated by subtracting a traffic volume of a path between a pair of nodes at one of the predetermined points of time in the past from the current traffic volume of the path is equal to or greater than a predetermined threshold value.

Consequently, the acquisition unit 2001 may acquire information to be used to evaluate whether or not data 1200 is transferred efficiently by the data transmission route nt and to determine whether or not the data transmission route nt is to be changed.

The determination unit 2002 determines whether or not the data transmission route nt is to be changed, based on the traffic volume of a path between each pair of nodes in the data transmission route nt on the OVERLAY network In including the plurality of nodes n, which is acquired by the acquisition unit 2001 from the plurality of nodes n.

The determination unit 2002 calculates, for example, the sum of the current traffic volume of a path between each pair of nodes and calculates the sum of the traffic volume of a path between each pair of nodes assuming that the data transmission route nt is changed based on information indicative of candidates for a pair of nodes to be connected to each other among a plurality of nodes n. The information indicative of candidates for a pair of nodes to be connected to each other is, for example, topology information. The topology information is information indicative of candidates for a connection relationship between each pair of nodes which may be changed in the OVERLAY network In. Then, the determination unit 2002 calculates the difference by subtracting the calculated sum of the traffic volume of a path between each pair of nodes assuming that the data transmission route nt is changed from the calculated sum of the current traffic volume of a path between each pair of nodes. Then, when the calculated difference is equal to or greater than a threshold value, the determination unit 2002 determines that the data transmission route nt is to be changed.

Consequently, the determination unit 2002 may determine by what degree the sum of the traffic volume in the data transmission route nt may be reduced from the current value when the data transmission route nt is changed. When the degree of the reduction in the sum of the traffic volume in the data transmission route nt is comparatively high, the determination unit 2002 may determine that the data 1200 may be transferred in a higher efficiency than the current efficiency when the data transmission route nt is changed. If the data 1200 may be transferred at a higher efficiency than the current efficiency when the data transmission route nt is changed, the determination unit 2002 may determine that the data transmission route nt is to be changed.

For example, based on the traffic volume of a path between each pair of nodes acquired by the acquisition unit 2001 from a plurality of nodes n at a plurality of points of time, the determination unit 2002 calculates an average value of the sum of the traffic volume of a path between each pair of nodes. Further, based on the topology information, the determination unit 2002 calculates the sum of the traffic volume of a path between each pair of nodes assuming that the data transmission route nt is changed. Then, the determination unit 2002 calculates the difference by subtracting the calculated sum of the traffic volume of a path between each pair of nodes assuming that the data transmission route nt is changed from the calculated average value of the sum of the traffic volume of a path between each pair of nodes. When the calculated difference is equal to or greater than a threshold value determined based on a standard deviation of the sum of the traffic volume of a path between each pair of nodes, the determination unit 2002 determines that the data transmission route nt is to be changed.

Consequently, the determination unit 2002 may determine by what degree the sum of the traffic volume in the data transmission route nt may be reduced from the current value when the data transmission route nt is changed. When the degree of the reduction in the sum of the traffic volume in the data transmission route nt is comparatively high, the determination unit 2002 may determine that the data 1200 may be transferred in a higher efficiency than the current efficiency when the data transmission route nt is changed. If the data 1200 may be transferred at a higher efficiency than the current efficiency when the data transmission route nt is changed, the determination unit 2002 may determine that the data transmission route nt is to be changed.

For example, when a difference calculated by subtracting the traffic volume of a path between a pair of nodes at a predetermined point of time from the current traffic volume of the path is equal to or greater than the threshold value, the determination unit 2002 determines that the data transmission route nt is to be changed. For example, when the acquisition unit 2001 acquires the notification indicating that the difference calculated by subtracting the traffic volume of a path between a pair of nodes at a predetermined point of time from the current traffic volume of the path is equal to or greater than the threshold value, the determination unit 2002 determines that the data transmission route nt is to be changed.

Consequently, the determination unit 2002 may determine that the traffic volume of a path between a pair of nodes of the data transmission route nt increases and there is the possibility that the data 1200 is unable to be transferred efficiently through the data transmission route nt. Then, if the possibility that the data 1200 is unable to be transferred efficiently through the data transmission route nt is comparatively high, the determination unit 2002 may determine that the data transmission route nt is to be changed.

When the determination unit 2002 determines that the data transmission route nt is to be changed, the identification unit 2003 identifies a pair of nodes to be newly connected to each other in the OVERLAY network In, based on the information indicative of candidates for a pair of nodes to be connected to each other among the plurality of nodes n and the acquired traffic volume of a path between each pair of nodes. Further, when the determination unit 2002 determines that the data transmission route nt is to be changed, the identification unit 2003 identifies a pair of nodes to be disconnected from each other in the OVERLAY network In, based on the information indicative of candidates for a pair of nodes to be connected to each other among the plurality of nodes n and the acquired traffic volume of a path between each pair of nodes.

The identification unit 2003 generates a connection matrix indicative of, for example, a connection relationship between each pair of nodes in the current OVERLAY network In. The connection relationship between each pair of nodes in the current OVERLAY network In may be stored in the route control apparatus 100 in advance and updated at a suitable point of time. The connection relationship between each pair of nodes in the current OVERLAY network In may be identified based on information acquired by the acquisition unit 2001 and indicative of the traffic volume of a path between each pair of nodes in the data transmission route nt on the OVERLAY network In. Then, the identification unit 2003 generates a connection matrix indicative of the connection relationship between each pair of nodes in the OVERLAY network In after the change, based on the information indicative of candidates for a pair of nodes to be connected to each other among the plurality of nodes n. Then, based on the two generated connection matrices, the identification unit 2003 identifies a pair of nodes to be newly connected to each other and a pair of nodes to be disconnected from each other in the OVERLAY network In.

Consequently, the identification unit 2003 may identify to which node n an addition request for a path that links the pair of nodes to be newly connected to each other to the data transmission route nt is to be transmitted. Further, the identification unit 2003 may identify to which node n a change request for changing the connection relationship between each pair of nodes in the OVERLAY network In is to be transmitted.

The addition unit 2004 transmits, based on the pair of nodes to be newly connected to each other identified by the identification unit 2003, an addition request for a path that links the pair of nodes to be newly connected to each other to the data transmission route nt to the nodes n to be newly connected to each other. The addition request is, for example, the issuance request 600 for a TEMPORARY SUBSCRIBE 1300 illustrated in FIG. 6. The issuance request 600 for a TEMPORARY SUBSCRIBE 1300, for example, is a request for causing the TEMPORARY SUBSCRIBE 1300 to be issued through a port directed toward the transmission terminal pt. The addition unit 2004 transmits the issuance request 600 for a TEMPORARY SUBSCRIBE 1300, for example, to one node n of the pair of nodes n between which a new link is to be established.

Consequently, the addition unit 2004 may cause a TEMPORARY SUBSCRIBE 1300 to be issued from one node n of the pair of nodes n between which a new link is to be established to the other node n of the pair. Then, the addition unit 2004 may add a new temporary path to the data transmission route nt.

Further, the addition unit 2004 transmits, to the pair of nodes n to be newly connected to each other, a redundancy removal request for discarding duplicative pieces of data 1200 having an identical content, which are received through different paths, while leaving one piece thereof. The redundancy removal request is, for example, the activation request 700 for activating the redundancy removal process illustrated in FIG. 7. The addition unit 2004 transmits the activation request 700, for example, to the pair of nodes n to be newly connected to each other.

Consequently, the addition unit 2004 may cause a node n to discard duplicative pieces of received data 1200 having an identical content while leaving one piece thereof and may avoid duplicative pieces of data 1200 having an identical content from being redundantly transferred from the node n.

After the temporary path is added to the data transmission route nt, based on the information on the pair of nodes to be newly connected to each other, the change unit 2005 transmits a change request for changing the connection relationship between each pair of nodes in the OVERLAY network In to the pair of nodes n to be newly connected to each other. Further, after the temporary path is added to the data transmission route nt, based on information on the pair of nodes to be disconnected from each other, the change unit 2005 transmits a change request for changing the connection relationship between each pair of nodes in the OVERLAY network In to the pair of nodes n to be disconnected from each other. The change request is, for example, the OVERLAY connection request 800 illustrated in FIG. 8 or the OVERLAY disconnection request 900 illustrated in FIG. 9.

Consequently, the change unit 2005 may remove, from the data transmission route nt, the path that links the pair of nodes to be disconnected from each other. Then, after the path that links the pair of nodes to be disconnected from each other is removed from the data transmission route nt, the change unit 2005 may avoid duplicative pieces of data 1200 having an identical content from being redundantly transmitted through different paths.

In the process of changing the connection relationship between each pair of nodes in the OVERLAY network In, the change unit 2005 transmits a change request such that, from among candidates for the connection relationship between each pair of nodes, a candidate for the connection relationship that indicates a higher reduction degree in the sum of the traffic volume in the OVERLAY network In than the other candidates is selected and the connection relationship transits to the selected candidate.

Consequently, the change unit 2005 may remove, from the data transmission route nt, the path that links the pair of nodes to be disconnected from each other. Then, the path that links the pair of nodes to be disconnected from each other is removed from the data transmission route nt, the change unit 2005 may avoid duplicative pieces of data 1200 having an identical content from being redundantly transmitted through different paths.

The node n includes an acceptance unit 2011, a first communication unit 2012, and a second communication unit 2013. The functions of the acceptance unit 2011 to the second communication unit 2013 are implemented by causing the CPU 401 to execute programs stored in the storage area of, for example, the memory 402 or the disk 405 illustrated in FIG. 4 or the like or by the network I/F 403. Processing results of the respective function units are stored in a storage area, for example, of the memory 402 or the disk 405 illustrated in FIG. 4.

The acceptance unit 2011 accepts an addition request for adding, to the data transmission route nt on the OVERLAY network In including a plurality of nodes n, a path to a second node n different from a first node n among the plurality of nodes n. The first node n is, for example, the own node n. The second node n is another node n that may directly communicate with the own node n. The acceptance unit 2011 accepts, for example, the issuance request 600 for a TEMPORARY SUBSCRIBE 1300.

The first communication unit 2012 adds a path to the data transmission route nt in response to acceptance of the addition request by the acceptance unit 2011. The first communication unit 2012 acquires, for example, the issuance destination node address included in the issuance request 600 for a TEMPORARY SUBSCRIBE 1300 in response to acceptance of the issuance request 600 for a TEMPORARY SUBSCRIBE 1300 by the acceptance unit 2011. Then, the first communication unit 2012 issues a TEMPORARY SUBSCRIBE 1300 through the basic network bn, based on the acquired issuance destination node address.

After the temporary path is added, when the first communication unit 2012 accepts data 1200 that passes the second node n, the first communication unit 2012 transmits the data 1200 through the added path. Further, if data 1200 that passes the second node n is accepted after the temporary path is added to the data transmission route nt and before a path is removed, the first communication unit 2012 may transmit the data 1200 through a path different from the temporary path in the data transmission route nt.

Consequently, the first communication unit 2012 may add the temporary path to the data transmission route nt. Even when some path is removed from the data transmission route nt, the first communication unit 2012 may maintain a state in which data 1200 may be transferred through the temporary path and does not give rise to a time period within which data 1200 does not reach the subscriber s from the publisher p.

In response to acceptance of a change request by the acceptance unit 2011, the second communication unit 2013 connects a pair of nodes to be newly connected to each other in the OVERLAY network In. For example, in response to acceptance of an OVERLAY connection request 800 by the acceptance unit 2011, the second communication unit 2013 acquires the to-be-connected node address included in the OVERLAY connection request 800. Then, the second communication unit 2013 transmits a connection request 1400 for a link in the OVERLAY network In, based on the acquired to-be-connected node address.

In response to acceptance of a change request by the acceptance unit 2011, the second communication unit 2013 disconnects a pair of nodes to be disconnected from each other in the OVERLAY network In and removes a path that links the pair of nodes from the data transmission route nt. The second communication unit 2013 acquires the to-be-disconnected node address included in the OVERLAY disconnection request 900, for example, in response to acceptance of the OVERLAY disconnection request 900 by the acceptance unit 2011. Then, the second communication unit 2013 transmits a disconnection request 1700 for the link in the OVERLAY network In on the basis of the acquired to-be-disconnected node address.

Consequently, the second communication unit 2013 may cause a path included in the data transmission route nt to serve as a path that links a pair of nodes connected to each other in the OVERLAY network In. Therefore, in a change of the data transmission route nt thereafter, the second communication unit 2013 may suppress formation of a loop by adding a path that links a pair of nodes that are not connected to each other in the OVERLAY network In.

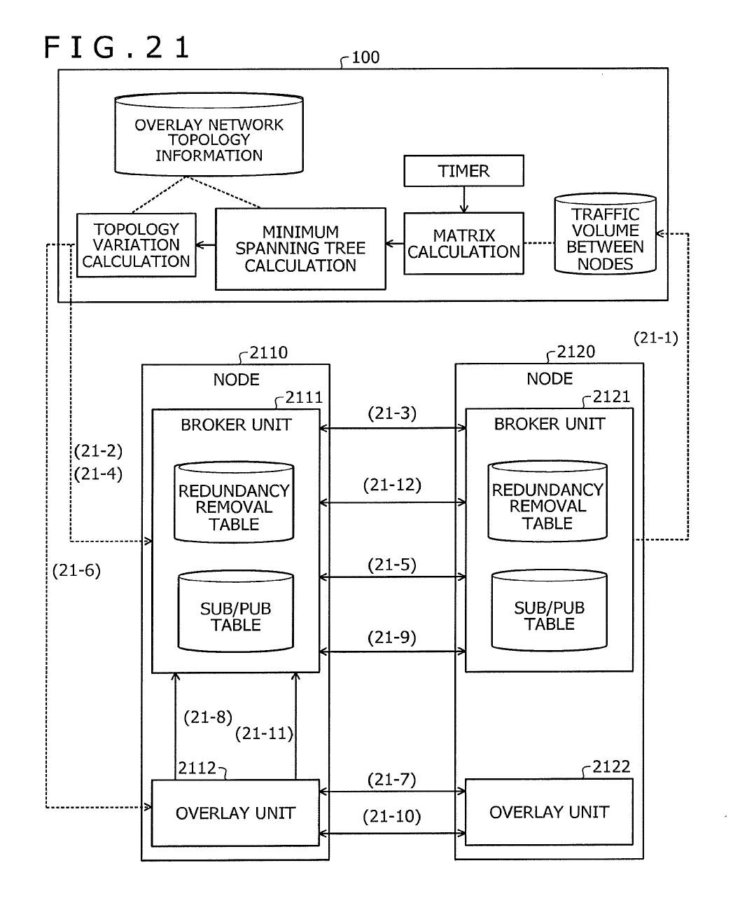

Now, operations of the route control apparatus 100 and the node n in the embodiment are described with reference to FIG. 21.

FIG. 21 is a diagram illustrating an example of operations of the route control apparatus 100 and a node n in the embodiment. The example of FIG. 21 is an example of a case in which the route control apparatus 100 is communicable with a node 2110 and another node 2120, and the node 2110 and the node 2120 are to be connected to each other or the node 2110 and the node 2120 are to be disconnected from each other.

The node 2110 includes a broker unit 2111 and an OVERLAY unit 2112. The broker unit 2111 is a component that controls the data transmission route nt or controls transfer of data 1200 through the data transmission route nt. The OVERLAY unit 2112 is a component for controlling the connection relationship between each pair of nodes in the OVERLAY network In. The node 2120 includes a broker unit 2121 and an OVERLAY unit 2122 similarly.

(21-1) The node 2120 measures the traffic volume of data 1200 for every predetermined period for each transmission source of the data 1200 and transmits a result of the measurement to the route control apparatus 100. The broker unit 2121 measures, for example, for every predetermined period, the traffic volume of the data 1200 received from the node 2110 and transmits information indicative of the measured traffic volume to the route control apparatus 100. The route control apparatus 100 receives the traffic volume of the data 1200 for each transmission source from the respective nodes n and stores the received traffic volume. Consequently, the route control apparatus 100 may store information to be used when it is determined whether or not the data transmission route nt is to be changed.

While a case is described here in which, every time the broker unit 2121 measures a traffic volume X, the broker unit 2121 transmits the traffic volume X to the route control apparatus 100, the embodiment is not limited to this. For example, the broker unit 2121 may determine, based on the measured traffic volume X, whether or not the measured traffic volume X is to be transmitted to the route control apparatus 100.

For example, the broker unit 2121 calculates a difference Y-X by subtracting the measured traffic volume X from a traffic volume Y within some period in the past. Then, when the calculated difference Y-X is equal to or greater than a threshold value, the broker unit 2121 transmits the measured traffic volume X to the route control apparatus 100 since the data transmission route nt is preferably changed.

In this case, the route control apparatus 100 issues a request for a traffic volume of the data 1200 for each transmission source to the broker unit of each of the nodes n in response to reception of the traffic volume X from the broker unit 2121. Then, the route control apparatus 100 collects the traffic volume of the data 1200 for each transmission source received from the broker units of the respective nodes n and stores the collected traffic volume. Consequently, the broker unit 2121 may reduce the traffic volume with the route control apparatus 100 and suppress the power consumption.

Then, every time a timer expires, the route control apparatus 100 generates a traffic volume matrix on the basis of the topology information of the OVERLAY network In and the stored traffic volume of the data 1200 for each transmission source. The route control apparatus 100 generates a spanning tree that minimizes the sum of the traffic volume on the basis of the generated traffic volume matrix. The spanning tree is a network that does not form any loop. In the description given below, the spanning tree that minimizes the sum of the traffic volume is sometimes referred to as “minimum spanning tree”.

After the minimum spanning tree is generated, the route control apparatus 100 calculates a difference by subtracting the sum of the traffic volume of a path between each pair of nodes in the OVERLAY network In corresponding to the minimum spanning tree from the sum of the traffic volume of a path between each pair of nodes in the current OVERLAY network In. Then, the route control apparatus 100 determines based on the calculated difference whether or not the data transmission route nt is to be changed. For example, if the calculated difference is greater than a predetermined threshold value, the route control apparatus 100 determines that the data transmission route nt is to be changed.

The route control apparatus 100 may apply a variable threshold value. For example, the route control apparatus 100 calculates an average value λb and a standard deviation σb of the sum of the traffic volume of a path between each pair of nodes, for example, within a period T in the past. Then, the route control apparatus 100 calculates the sum λa of the traffic volume of a path between each pair of nodes in the OVERLAY network In corresponding to the minimum spanning tree. Then, the route control apparatus 100 adopts N×σb as a threshold value and determines that the data transmission route nt is to be changed when λb-λa>N×σb is satisfied. Here, T and N may be adjusted depending on the magnitude of the difference and an expected magnitude of the difference.

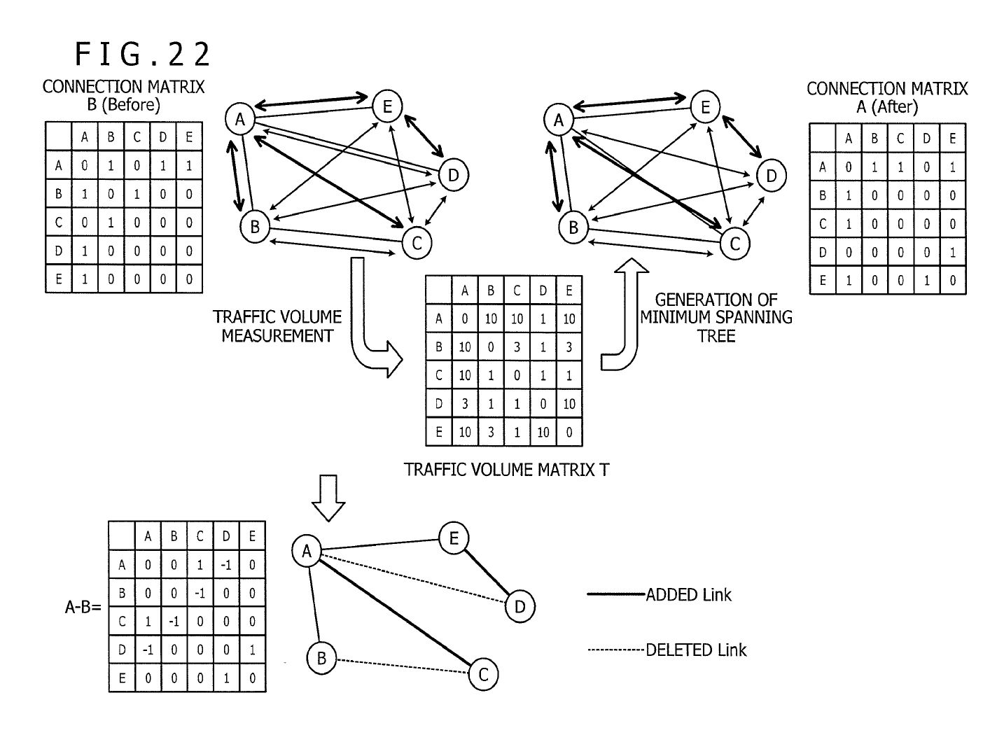

If the route control apparatus 100 determines that the data transmission route nt is to be changed, the route control apparatus 100 generates a connection matrix corresponding to the spanning tree indicative of the current OVERLAY network In and a connection matrix corresponding to the minimum spanning tree. Then, the route control apparatus 100 identifies a pair of nodes to be newly connected to each other and a pair of nodes to be disconnected from each other in the OVERLAY network In. Here, referring to FIG. 22, an example for generating a minimum spanning tree and an example for determining a pair of nodes to be newly connected to each other and a pair of nodes to be disconnected from each other in the OVERLAY network In are described.

FIG. 22 is a diagram illustrating an example of generation of a minimum spanning tree. Referring to FIG. 22, the route control apparatus 100 generates a connection matrix B corresponding to the spanning tree indicating the current OVERLAY network In and generates a traffic volume matrix T on the basis of the generated connection matrix B. Then, the route control apparatus 100 generates a minimum spanning tree on the basis of the traffic volume matrix T.

The route control apparatus 100 generates a minimum spanning tree, for example, using an exhaustive search algorithm. (i) The route control apparatus 100, for example, provisionally sets the sum of the traffic volume of a path between each pair of nodes in the candidate for the minimum spanning tree to “infinity”. (ii) The route control apparatus 100 selects one of generable spanning trees. (iii) The route control apparatus 100 calculates the sum of the traffic volume of a path between each pair of nodes in the selected spanning tree on the basis of the traffic volume matrix T. (iv) The route control apparatus 100 compares the sum of the traffic volume of a path between each pair of nodes in the candidate for the minimum spanning tree and the sum of the traffic volume of a path between each pair of nodes in the selected spanning tree with each other.

(v) If the sum of the traffic volume of a path between each pair of nodes in the selected spanning tree is smaller, the route control apparatus 100 sets the selected spanning tree as the candidate for the minimum spanning tree. (vi) The route control apparatus 100 sets the sum of the traffic volume of a path between each pair of nodes in the selected spanning tree as the sum of the traffic volume of a path between each pair of nodes in the candidate for the minimum spanning tree. (vii) The route control apparatus 100 repeats (ii) to (vi) for all of the generable spanning trees and adopts the spanning tree set as the candidate for the minimum spanning tree as the minimum spanning tree.

Alternatively, the route control apparatus 100 may calculate a minimum spanning tree using, for example, a heuristic algorithm. The heuristic algorithm is, for example, the Kruskal's algorithm or the Prim's MST algorithm. For example, the route control apparatus 100 sets, as a cost of a link between a pair of nodes, a value derived by multiplying an inverse of the traffic volume of a path between each pair of nodes by a predetermined coefficient, on the basis of the traffic volume matrix T. That is, the route control apparatus 100 sets, as the cost, a value that decreases as the traffic volume of a path between each pair of nodes increases. Then, the route control apparatus 100 repeats a process for selecting and establishing a link of the lowest cost among links between each pair of nodes until a spanning tree is generated. Then, the route control apparatus 100 sets the generated spanning tree as the minimum spanning tree.

After the minimum spanning tree is set, the route control apparatus 100 calculates the difference by subtracting the sum of the traffic volume of a path between each pair of nodes in the OVERLAY network In corresponding to the minimum spanning tree from the sum of the traffic volume of a path between each pair of nodes in the current OVERLAY network In. Then, the route control apparatus 100 determines whether or not the data transmission route nt is to be changed based on the calculated difference. For example, if the calculated difference is greater than a predetermined threshold value, the route control apparatus 100 determines that the data transmission route nt is to be changed.

The route control apparatus 100 generates a connection matrix A corresponding to the minimum spanning tree. Then, the route control apparatus 100 identifies a pair of nodes to be newly connected to each other and a pair of nodes to be disconnected from each other in the OVERLAY network In on the basis of a matrix of a result of the arithmetic operation of (connection matrix A-connection matrix B). The route control apparatus 100 identifies, for example, a pair of nodes corresponding to an element of “−1” in the matrix of the result of the arithmetic operation as a pair of nodes to be disconnected from each other. Further, the route control apparatus 100 identifies, for example, a pair of nodes corresponding to an element “1” of the matrix of the result of the arithmetic operation as a pair of nodes to be newly connected to each other.

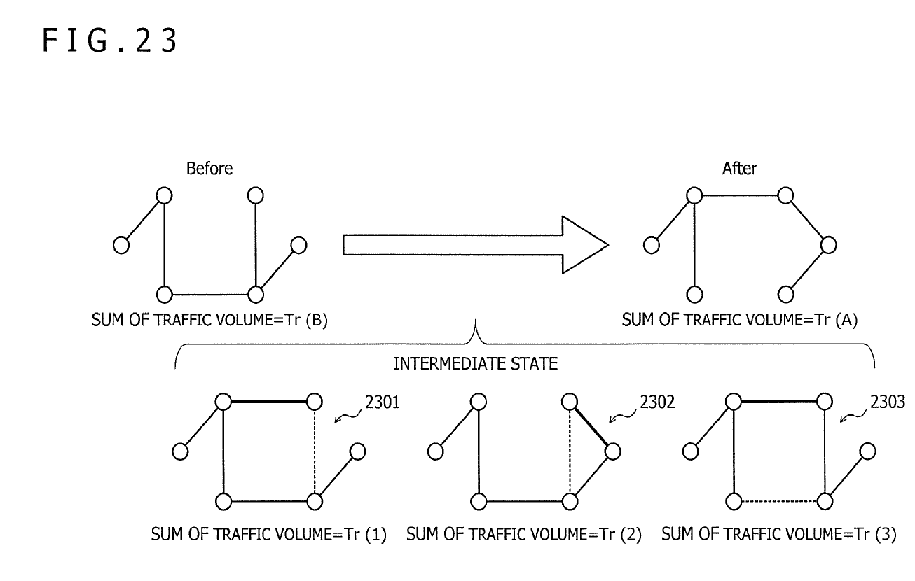

After the route control apparatus 100 identifies the pair of nodes to be newly connected to each other and the pair of nodes to be disconnected from each other in the OVERLAY network In, the route control apparatus 100 determines a change sequence of the connection relationship between each pair of nodes in the OVERLAY network In. Here, an example for determining a change sequence of the connection relationship between each pair of nodes in the OVERLAY network In is described with reference to FIG. 23.

FIG. 23 is a diagram illustrating an example for determining a change sequence of a connection relationship between each pair of nodes in the OVERLAY network In. As illustrated in FIG. 23, the process of transition from the connection relationship between each pair of nodes in the current OVERLAY network In to the connection relationship between each pair of nodes in the OVERLAY network In after the change sometimes involves a plurality of intermediate states. In the example of FIG. 23, intermediate states 2301 to 2303 are involved.

In this case, the route control apparatus 100 calculates the sum of the traffic volume of a path between each pair of nodes in the OVERLAY network In in each of the intermediate states. Then, the route control apparatus 100 selects the intermediate state which has the maximum reduction degree from the sum of the traffic volume of a path between each pair of nodes in the current OVERLAY network In and determines an order of connecting or disconnecting ach pair of nodes to transit to the selected intermediate state.

In the example of FIG. 23, the route control apparatus 100 respectively calculates the sums Tr(1) to Tr(3) of the traffic volume for the intermediate states 2301 to 2303. Then, the route control apparatus 100 calculates the difference between the sum Tr(B) of the traffic volume of a path between each pair of nodes in the current OVERLAY network In and the respective sums Tr(1) to Tr(3) of the traffic volume for the intermediate states 2301 to 2303. The route control apparatus 100 selects the intermediate state which has the maximum calculated difference and determines an order of connecting or disconnecting each pair of nodes to transit to the selected intermediate state.

Referring back to FIG. 21, (21-2) the route control apparatus 100 transmits an issuance request 600 for a TEMPORARY SUBSCRIBE 1300 to the node n of the pair of nodes n to be newly connected to each other, which is positioned nearer to the reception terminal st. In the example of FIG. 21, the route control apparatus 100 transmits, to the node 2110, an issuance request 600 for a TEMPORARY SUBSCRIBE 1300 including information indicative of the node 2120 as the connection destination.

(21-3) In the node 2110, the broker unit 2111 receives the issuance request 600 for a TEMPORARY SUBSCRIBE 1300 from the route control apparatus 100. The broker unit 2111 issues a TEMPORARY SUBSCRIBE 1300 to the node 2120 on the basis of the issuance request 600 for a TEMPORARY SUBSCRIBE 1300. Consequently, the broker unit 2111 may add a temporary path from the second broker b to the first broker b to the data transmission route nt.

(21-4) The route control apparatus 100 further transmits an activation request 700 for a redundancy removal process to the node 2110. In the node 2110, the broker unit 2111 receives the activation request 700 for a redundancy removal process. The broker unit 2111 activates a redundancy removal process in response to the activation request 700. Consequently, the broker unit 2111 may suppress transfer of duplicative pieces of data 1200 having an identical content even when the broker unit 2111 receives duplicative pieces of data 1200 having an identical content redundantly through different paths.

(21-5) In the node 2120, the broker unit 2121 transmits data 1200 to the node 2110 using the added temporary path. Further, the broker unit 2121 transmits another piece of data 1200 having a content, which is identical to the content of the data 1200 transmitted to the node 2110 using the added temporary path, to the node 2110 via another node n using a path other than the added temporary path. Since the redundancy removal process is activated in the broker unit 2111, even if the broker unit 2111 receives duplicative pieces of data 1200 having an identical content, the broker unit 2111 does not redundantly transfer the data 1200.

Consequently, even if a path other than the added temporary path is deleted during changing of the connection relationship between each pair of nodes in the OVERLAY network In, the broker unit 2121 may continue to transmit data 1200 to the node 2110. Therefore, there is no period within which data 1200 transmitted from the broker unit 2121 does not reach the broker unit 2111.

(21-6) The route control apparatus 100 transmits a change request for changing the connection relationship between each pair of nodes in the OVERLAY network In to the pair of nodes n to be newly connected to each other and the pair of nodes n to be disconnected from each other. The change request is, for example, an OVERLAY connection request 800 or an OVERLAY disconnection request 900. In the example of FIG. 21, the route control apparatus 100 transmits an OVERLAY connection request 800 including information indicative of the node 2120 as the to-be-connected destination to the node 2110.

(21-7) In the node 2110, the OVERLAY unit 2112 receives the OVERLAY connection request 800. The OVERLAY unit 2112 transmits a connection request 1400 for a link in the OVERLAY network In to the node 2120 on the basis of the OVERLAY connection request 800. When the OVERLAY unit 2122 in the node 2120 receives the connection request 1400 for a link, the link between the node 2110 and the node 2120 is established.

(21-8) After the link between the node 2110 and the node 2120 is established, the OVERLAY unit 2112 in the node 2110 transmits an OVERLAY connection notification 1500 to the broker unit 2111.

(21-9) When the broker unit 2111 in the node 2110 receives the OVERLAY connection notification 1500, the broker unit 2111 transmits a SUBSCRIBE 1600 to the node 2120 in response to the establishment of the link in the OVERLAY network In. Consequently, the node 2110 may add the path for linking to the node 2120 to the data transmission route nt to overwrite the temporary path. Since the temporary path exists, the node 2110 may omit transmission of the SUBSCRIBE 1600.

Here, also a case is described with reference to FIG. 21 in which the route control apparatus 100 transmits a change request for changing the connection relationship between each pair of nodes in the OVERLAY network In to a pair of nodes n to be disconnected from each other. In the following, it is assumed that the link between the node 2110 and the node 2120 is cut.

(21-10) In the node 2110, the OVERLAY unit 2112 receives an OVERLAY disconnection request 900. The OVERLAY unit 2112 transmits a disconnection request 1700 for a link in the OVERLAY network In to the node 2120 on the basis of the OVERLAY disconnection request 900. In the node 2120, when the OVERLAY unit 2122 receives the disconnection request 1700 for a link, the OVERLAY unit 2122 cuts the link between the node 2110 and the node 2120.

(21-11) In the node 2110, when the link between the node 2110 and the node 2120 is cut, the OVERLAY unit 2112 transmits an OVERLAY disconnection notification 1800 to the broker unit 2111.

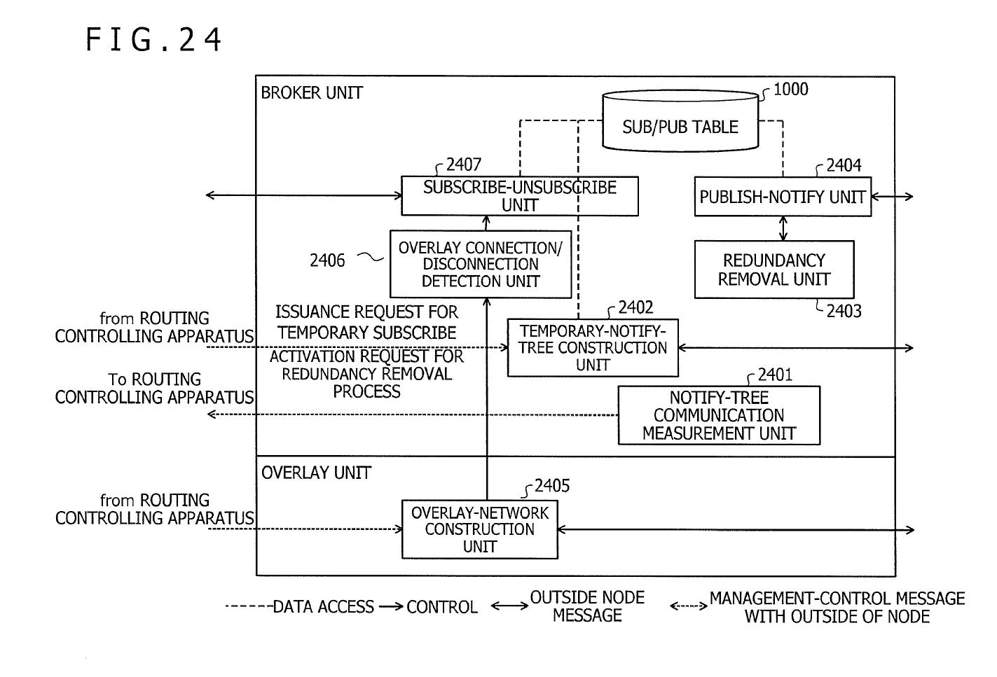

(21-12) In the node 2110, when the broker unit 2111 receives the OVERLAY disconnection notification 1800, the broker unit 2111 transmits an UNSUBSCRIBE 1900 to the node 2120 in response to the cutting of the link in the OVERLAY network In. Consequently, the node 2110 may delete the path linking to the node 2120 from the data transmission route nt. Here, description is given with reference to FIG. 24.

FIG. 24 is a diagram illustrating a particular example of components of the node n illustrated in FIG. 21. As illustrated in FIG. 24, the node n includes, in the broker unit, a NOTIFY-tree communication measurement unit 2401, a temporary-NOTIFY-tree construction unit 2402, a redundancy removal unit 2403, and a publish-NOTIFY unit 2404. Further, the node n includes, in the OVERLAY unit, an OVERLAY-network construction unit 2405. Further, the node n includes, in the broker unit, an OVERLAY connection/disconnection detection unit 2406 and a SUBSCRIBE-UNSUBSCRIBE unit 2407.

The NOTIFY-tree communication measurement unit 2401 is a component for measuring the traffic volume of data 1200 for each transmission source and transmitting the measured traffic volume to the route control apparatus 100. The temporary-NOTIFY-tree construction unit 2402 is a component that receives an issuance request 600 for a TEMPORARY SUBSCRIBE 1300 from the route control apparatus 100 and issues a TEMPORARY SUBSCRIBE 1300. The temporary-NOTIFY-tree construction unit 2402 is a component that receives an activation request 700 for a redundancy removal process from the route control apparatus 100 and activates the redundancy removal unit 2403.

The redundancy removal unit 2403 is a component that executes a redundancy removal process and controls the publish-NOTIFY unit 2404. The publish-NOTIFY unit 2404 is a component that controls transmission and reception of a PUBLISH or data 1200 to and from another node n. The publish-NOTIFY unit 2404 is a component that discards, if the publish-NOTIFY unit 2404 redundantly receives duplicative pieces of data 1200 having an identical content, the duplicative pieces of received data 1200 while leaving one piece thereof under the control of the redundancy removal unit 2403.

The OVERLAY-network construction unit 2405 is a component that receives an OVERLAY connection request 800 from the route control apparatus 100 and transmits a connection request 1400 for a link of the OVERLAY network In to change the OVERLAY network In. The OVERLAY-network construction unit 2405 is a component that receives an OVERLAY disconnection request 900 from the route control apparatus 100 and transmits a disconnection request 1700 for a link of the OVERLAY network In to change the OVERLAY network In. The OVERLAY-network construction unit 2405 is a component that transmits, when the own node n is connected to or disconnected from another node n in the OVERLAY network In, an OVERLAY connection notification 1500 or an OVERLAY disconnection notification 1800 to the OVERLAY connection/disconnection detection unit 2406.

The OVERLAY connection/disconnection detection unit 2406 is a component that detects connection/disconnection to/from another node n in the OVERLAY network In and controls the SUBSCRIBE-UNSUBSCRIBE unit 2407. The OVERLAY connection/disconnection detection unit 2406 is a component that receives an OVERLAY connection notification 1500 or an OVERLAY disconnection notification 1800 from the OVERLAY-network construction unit 2405 and controls the SUBSCRIBE-UNSUBSCRIBE unit 2407.

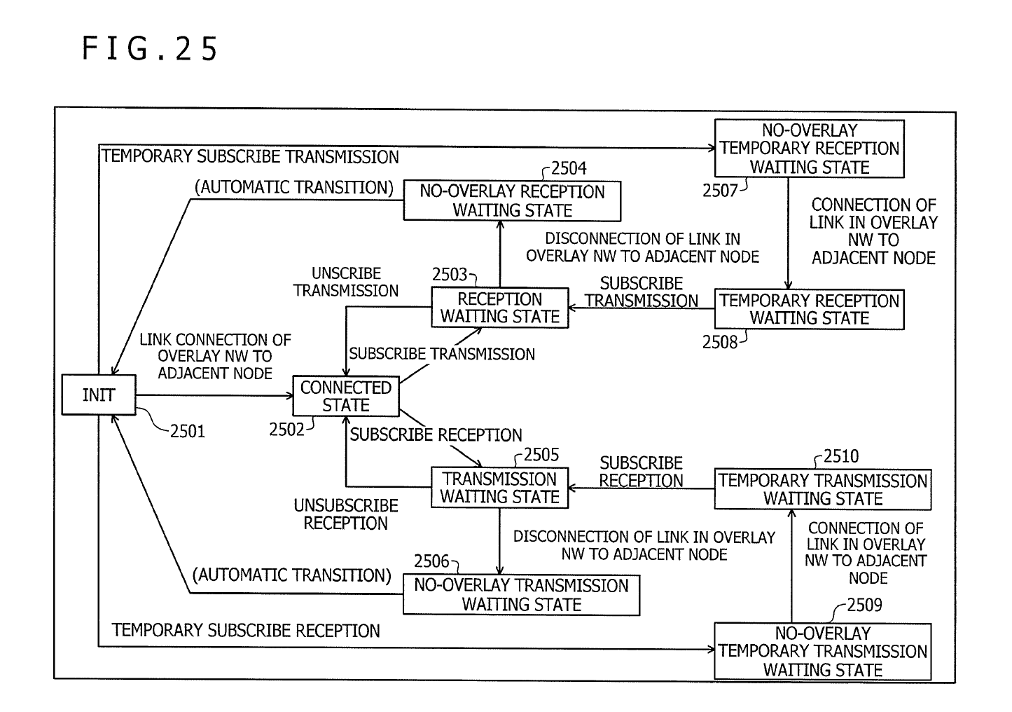

The SUBSCRIBE-UNSUBSCRIBE unit 2407 is a component that changes the data transmission route nt under the control of the OVERLAY connection/disconnection detection unit 2406. The SUBSCRIBE-UNSUBSCRIBE unit 2407 is a component that transmits a SUBSCRIBE 1600 or an UNSUBSCRIBE 1900 to another node n, for example, in response to connection or disconnection to or from the other node n in the OVERLAY network In. Here, description is given with reference to FIG. 25.

FIG. 25 is a diagram illustrating a state transition of a node n. As illustrated in FIG. 25, if the node n establishes a link in the OVERLAY network In to an adjacent node n in an initial state 2501, the node n advances to a connected state 2502. The adjacent node n is a node n that exists within a communication range of the node n.

When the node n transmits a SUBSCRIBE 1600 in the connected state 2502, the node n advances to a reception waiting state 2503 in which the node n waits for reception of data 1200. After the reception waiting state 2503 transmits an UNSUBSCRIBE 1900 in the reception waiting state 2503, the node n returns to the connected state 2502. If a link in the OVERLAY network In is cut in the reception waiting state 2503, the node n advances to a no-OVERLAY reception waiting state 2504 in which the node n waits for reception of data 1200 without through the OVERLAY network In. The node n returns from the no-OVERLAY reception waiting state 2504 to the initial state 2501.

If the node n receives a SUBSCRIBE 1600 in the connected state 2502, the node n advances to a transmission waiting state 2505 in which the node n waits for transmission of data 1200. If the node n receives an UNSUBSCRIBE 1900 in the transmission waiting state 2505, the node n returns to the connected state 2502. If a link in the OVERLAY network In is cut in the transmission waiting state 2505, the node n advances to a no-OVERLAY transmission waiting state 2506 in which the node n waits for transmission of data 1200 without through the OVERLAY network In. The node n transmits an UNSUBSCRIBE 1900 to an upstream node in the no-OVERLAY transmission waiting state 2506 and then returns to the initial state 2501.

If the node n transmits a TEMPORARY SUBSCRIBE 1300 in the initial state 2501, the node n advances to a no-OVERLAY temporary reception waiting state 2507 in which the node n waits for reception of data 1200 without through the OVERLAY network In. If a link in the OVERLAY network In is established in the no-OVERLAY temporary reception waiting state 2507, the node n advances to a temporary reception waiting state 2508 in which the node n waits for reception of the data 1200 through the OVERLAY network In. After the node n transmits a SUBSCRIBE 1600 in the temporary reception waiting state 2508, the node n returns to the reception waiting state 2503.

If the node n receives a TEMPORARY SUBSCRIBE 1300 in the initial state 2501, the node n advances to a no-OVERLAY temporary transmission waiting state 2509 in which the node n waits for transmission of data 1200 without through the OVERLAY network In. If a link in the OVERLAY network In is established in the no-OVERLAY temporary transmission waiting state 2509, the node n advances to a temporary transmission waiting state 2510 in which the node n waits for transmission of data 1200 through the OVERLAY network In. If the node n receives a SUBSCRIBE 1600 in the temporary transmission waiting state 2510, it returns to the transmission waiting state 2505.

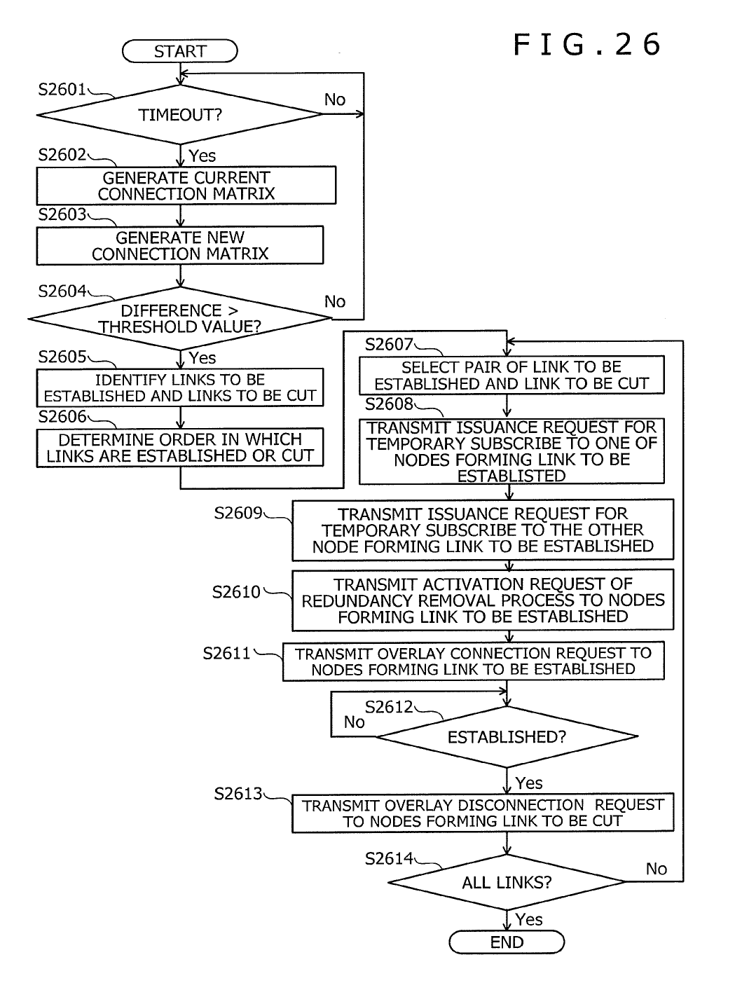

Now, an example of a route control process is described with reference to FIG. 26.

FIG. 26 is a flowchart illustrating an example of the route control process. Referring to FIG. 26, the route control apparatus 100 determines whether or not the timer expires (S2601). If the timer does not expire (S2601: No), the route control apparatus 100 returns to S2601.

If the timer expires (S2601: Yes), the route control apparatus 100 acquires the traffic volume of a path between each pair of nodes in a NOTIFY tree and generates a matrix indicative of a connection matrix of the current OVERLAY network In (S2602). Then, the route control apparatus 100 generates a matrix indicative of a connection matrix of the new OVERLAY network In, which has the minimum sum of the traffic volume of a path between each pair of nodes (S2603).

Then, the route control apparatus 100 determines whether or not the difference derived by subtracting the sum of the traffic volume of a path between each pair of nodes in the new OVERLAY network In from the sum of the traffic volume of a path between each pair of nodes in the current OVERLAY network In is greater than a predetermined threshold value (S2604). If the difference is equal to or smaller than the threshold value (S2604: No), the route control apparatus 100 returns to S2601.

If the difference is greater than the threshold value (S2604: Yes), the route control apparatus 100 identifies links to be newly established and links to be cut in the OVERLAY network In on the basis of the two matrices (S2605). Then, the route control apparatus 100 determines an order of establishment or cutting of a link without forming a loop during the process of changing from the current OVERLAY network In to the new OVERLAY network In (S2606).

Then, the route control apparatus 100 selects a pair of a link to be established and a link to be cut based on the determined order (S2607). Then, the route control apparatus 100 transmits, to one of the pair of nodes n that are to form the selected link to be established, an issuance request 600 for a TEMPORARY SUBSCRIBE 1300 for establishing a link to the other node n in the NOTIFY tree (S2608).

Further, the route control apparatus 100 transmits, to the other of the pair of nodes n that are to form the selected link to be established, an issuance request 600 for a TEMPORARY SUBSCRIBE 1300 for establishing a link to the one node n in the NOTIFY tree (S2609). Then, the route control apparatus 100 transmits an activation request 700 for the redundancy removal process to the pair of nodes n that are to form the link to be established (S2610).

Thereafter, the route control apparatus 100 transmits an OVERLAY connection request 800 for establishing the link to be established to the pair of nodes n that are to form the link to be established (S2611). Then, the route control apparatus 100 determines whether or not the link to be established is established (S2612). If the link to be established is not established (S2612: No), the route control apparatus 100 returns to S2612.

If the link to be established is established (S2612: Yes), the route control apparatus 100 transmits an OVERLAY disconnection request 900 for cutting the link to be cut to the pair of nodes n that form the link to be cut (S2613). Then, the route control apparatus 100 determines whether or not all links have been selected from the links to be established and the links to be cut (S2614). If a link that has not been selected remains (S2614: No), the route control apparatus 100 returns to S2607.

If all of the links have been selected (S2614: Yes), the route control apparatus 100 ends the route control process.

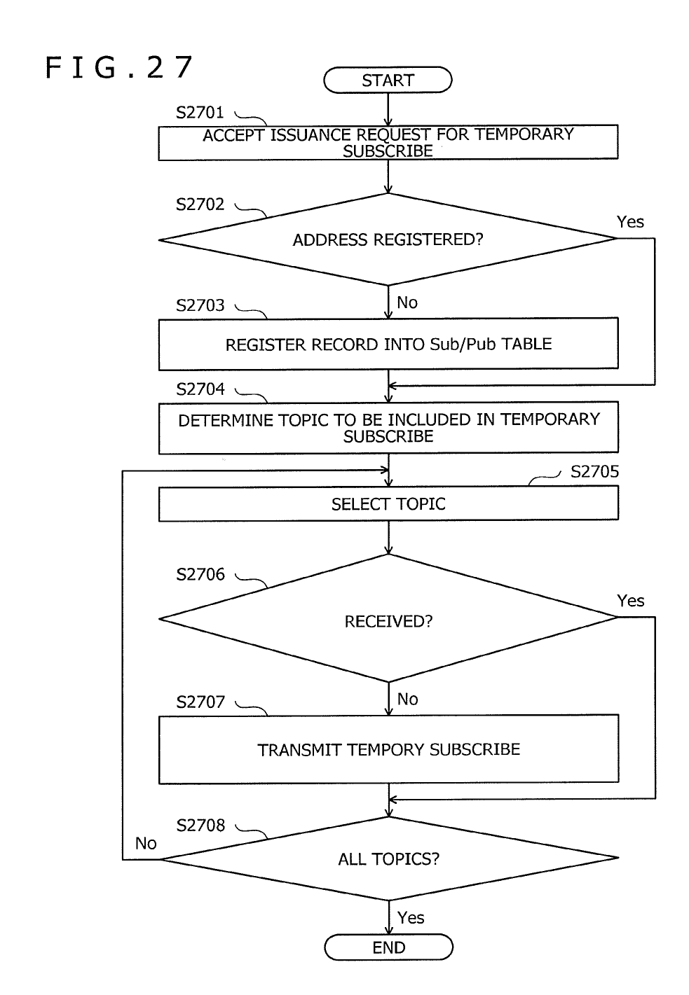

Now, an example of a TEMPORARY SUBSCRIBE issuance process is described with reference to FIG. 27.

FIG. 27 is a flowchart illustrating the TEMPORARY SUBSCRIBE issuance process. Referring to FIG. 27, a node n accepts an issuance request 600 for a TEMPORARY SUBSCRIBE 1300 for establishing a link from the own node n to an adjacent node n in a NOTIFY tree (S2701).

Then, the node n determines based on the Sub/Pub table 1000 whether or not an address of the adjacent node n that serves as a connection destination is registered in association with one of the ports (S2702). If the address is registered (S2702: Yes), the node n advances to S2704.

If the address is not yet registered (S2702: No), the node n registers a record in the Sub/Pub table 1000 in association with the address of the node n that serves as the connection destination (S2703). Then, the node n determines topics to be included in the TEMPORARY SUBSCRIBE 1300 to be transmitted to the adjacent node n that serves as the connection destination among topics already registered in the Sub/Pub table 1000 (S2704).

Then, the node n selects one of the determined topics (S2705). Then, the node n determines whether or not the selected topic is the same as a topic included in a SUBSCRIBE 1600 received in the past from the adjacent node n that serves as the connection destination (S2706). If the selected topic is the same (S2706: Yes), the node n advances to S2708.

If the selected topic is not the same (S2706: No), the node n transmits a TEMPORARY SUBSCRIBE 1300 including the selected topic and the address of the own node n to the adjacent node n that serves as the connection destination (S2707). Then, the node n determines whether or not all of the determined topics have been selected (S2708). If there remains a determined topic that has not yet been selected (S2708: No), the node n returns to S2705.

If all of the determined topics have been selected (S2708: Yes), the node n ends the TEMPORARY SUBSCRIBE issuance process.

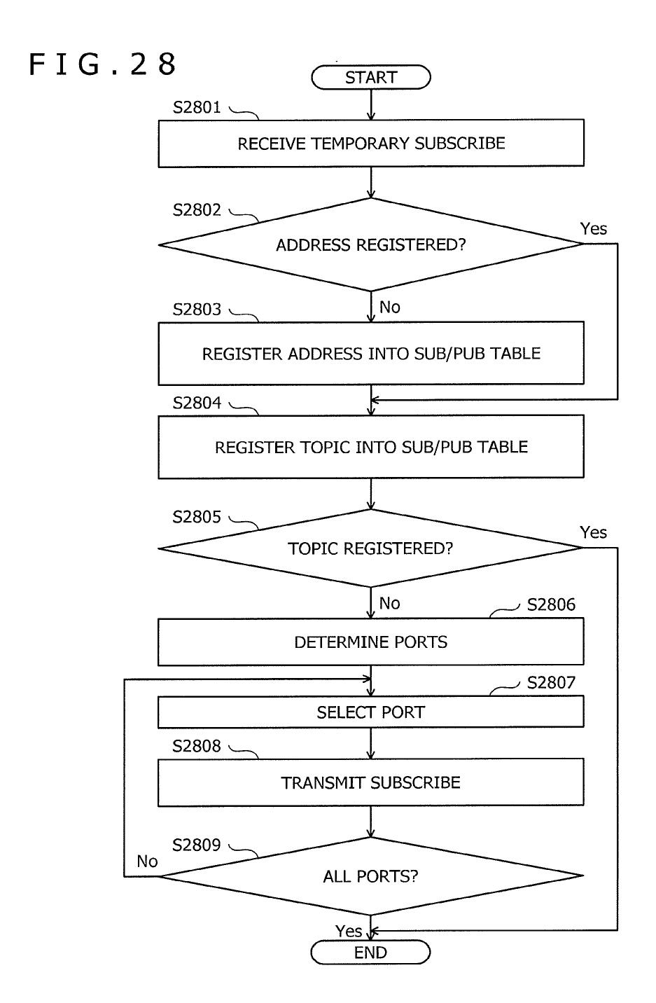

Now, an example of a TEMPORARY SUBSCRIBE reception process is described with reference to FIG. 28.

FIG. 28 is a flowchart illustrating the TEMPORARY SUBSCRIBE reception process. Referring to FIG. 28, a node n receives a TEMPORARY SUBSCRIBE 1300 including a topic and an address of a connection destination node n (S2801).

Then, the node n determines whether or not the address of the connection destination node n is already registered in the Sub/Pub table 1000 in association with a port at which the TEMPORARY SUBSCRIBE 1300 is received (S2802). If the address of the connection destination node n is already registered (S2802: Yes), the node n advances to S2804.

If the address of the connection destination node n is not yet registered (S2802: No), the node n registers a record in which the port at which the TEMPORARY SUBSCRIBE 1300 is received and the address of the connection destination node n are associated with each other into the Sub/Pub table 1000 (S2803).

Then, the node n registers the topic included in the TEMPORARY SUBSCRIBE 1300 into the Sub/Pub table 1000 in association with the port at which the TEMPORARY SUBSCRIBE 1300 is received (S2804). Then, the node n determines whether or not the topic is already registered in association with a port other than the port at which the SUBSCRIBE 1600 is received (S2805). If the topic is already registered (S2805: Yes), the node n ends the TEMPORARY SUBSCRIBE reception process.

If the topic is not yet registered (S2805: No), the node n determines ports other than the port at which the TEMPORARY SUBSCRIBE 1300 is received (S2806). Then, the node n selects one of the determined ports (S2807). Then, the node n transmits a SUBSCRIBE 1600 including the topic and the address of the own node n from the selected port (S2808).

Then, the node n determines whether or not all of the determined ports have been selected (S2809). If there remains a determined port that has not yet been selected (S2809: No), the node n returns to S2807.

If all of the determined ports have been selected (S2809: Yes), the node n ends the SUBSCRIBE reception process.

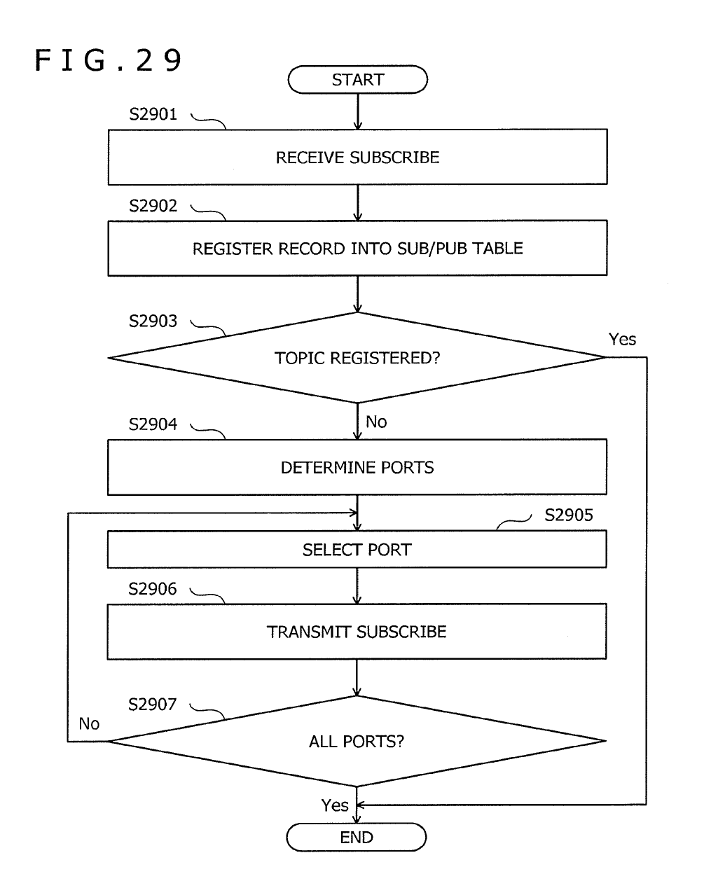

Now, an example of a SUBSCRIBE reception process is described with reference to FIG. 29.

FIG. 29 is a flowchart illustrating an example of the SUBSCRIBE reception process. Referring to FIG. 29, a node n receives a SUBSCRIBE 1600 including a topic and an address of a connection destination node n (S2901). Then, the node n registers a record in which the topic and the address of the connection destination node n are associated with each other into the Sub/Pub table 1000 (S2902).

Then, the node n determines whether or not a topic is already registered in association with a port other than the port at which the SUBSCRIBE 1600 is received (S2903). If the topic is already registered (S2903: Yes), the node n ends the SUBSCRIBE reception process.

If the topic is not yet registered (S2903: No), the node n determines ports other than the port at which the SUBSCRIBE 1600 is received (S2904). Then, the node n selects one of the determined ports (S2905). Then, the node n transmits a SUBSCRIBE 1600 including the topic and the address of the own node n from the selected port (S2906).

Then, the node n determines whether or not all of the determined ports have been selected (S2907). If there remains a determined port that has not yet been selected (S2907: No), the node n returns to S2905.

If all of the determined ports have been selected (S2907: Yes), the node n ends the SUBSCRIBE reception process.

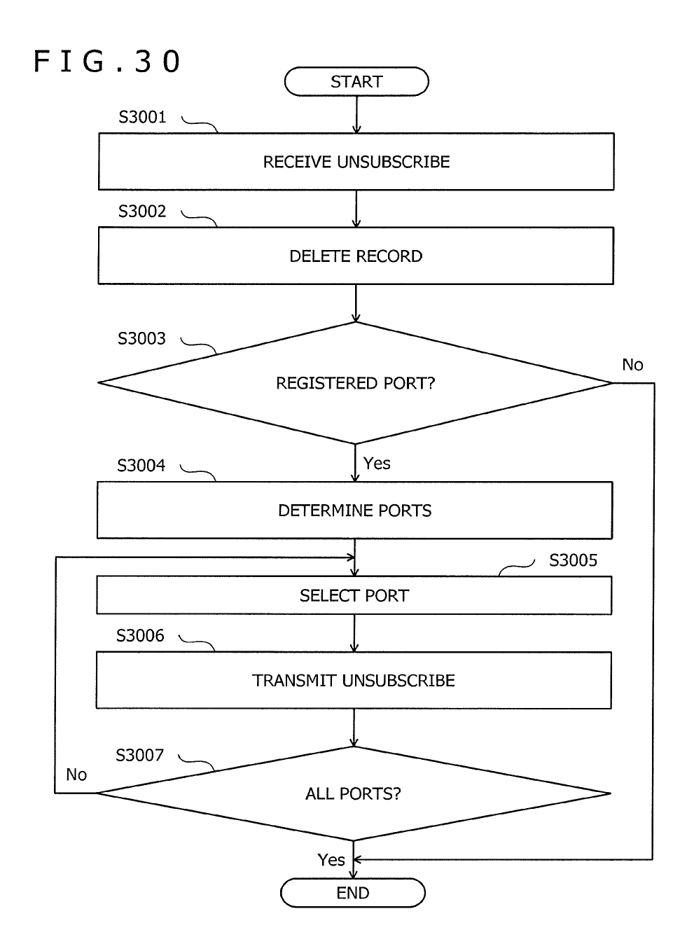

Now, an example of an UNSUBSCRIBE reception process is described with reference to FIG. 30.

FIG. 30 is a flowchart illustrating the UNSUBSCRIBE reception process. Referring to FIG. 30, a node n receives an UNSUBSCRIBE 1900 including a topic and an address of a connection destination node n (S3001). Then, the node n deletes a record in which the topic and the address of the connection destination node n included in the UNSUBSCRIBE 1900 are associated with each other from the Sub/Pub table 1000 (S3002).

Then, the node n determines whether or not a port other than the port at which the UNSUBSCRIBE 1900 is received is registered in the Sub/Pub table 1000 in association with the topic included in the UNSUBSCRIBE 1900 (S3003). If no such port is registered (S3003: No), the node n ends the UNSUBSCRIBE reception process.

If such port is registered (S3003: Yes), the node n determines ports other than the port at which the UNSUBSCRIBE 1900 is received (S3004). Then, the node n selects one of the determined ports (S3005). Then, the node n transmits an UNSUBSCRIBE 1900 including the topic and the address of the own node n from the selected port (S3006).

Then, the node n determines whether or not all of the determined ports have been selected (S3007). If there remains a determined port that has not yet been selected (S3007: No), the node n returns to S3005.

If all of the determined ports have been selected (S3007: Yes), the node n ends the UNSUBSCRIBE reception process.

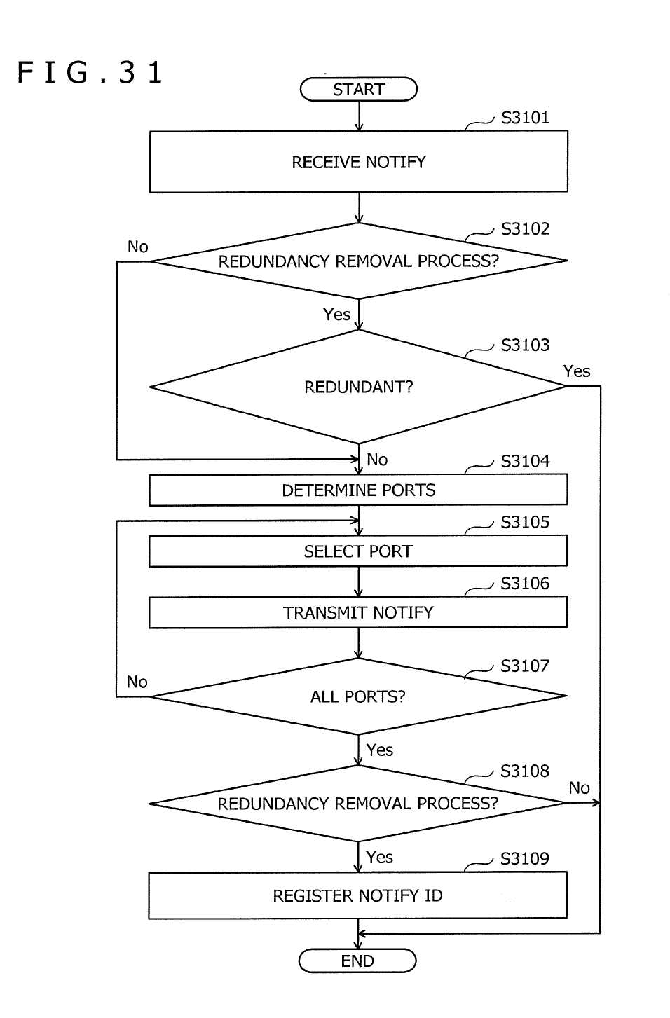

Now, an example of a NOTIFY reception process is described with reference to FIG. 31.

FIG. 31 is a flowchart illustrating the NOTIFY reception process. Referring to FIG. 31, a node n receives a NOTIFY including a topic, a NOTIFY ID, and an address of a node n that serves as a destination of the NOTIFY (S3101).

Then, the node n determines whether or not the redundancy removal process is activated (S3102). If the redundancy removal process is deactivated (S3102: No), the node n advances to S3104.

If the redundancy removal process is activated (S3102: Yes), the node n determines whether or not the received NOTIFY is a NOTIFY already received from a different path and registered in the redundancy removal table 1100 (S3103). If the NOTIFY is an already registered NOTIFY (S3103: Yes), the node n ends the NOTIFY reception process.

If the NOTIFY is not an already registered NOTIFY (S3103: No), the node n determines ports registered in the Sub/Pub table 1000 in association with the topic included in the NOTIFY (S3104).

Then, the node n selects one of the determined ports (S3105). Then, the node n transmits the NOTIFY from the selected port (S3106). Then, the node n determines whether or not all of the determined ports have been selected (S3107). If there remains a determined port that has not yet been selected (S3107: No), the node n returns to S3105.

If all of the determined ports have been selected (S3107: Yes), the node n determines whether or not the redundancy removal process is activated (S3108). If the redundancy removal process is deactivated (S3108: No), the node n ends the NOTIFY reception process.

If the redundancy removal process is activated (S3108: Yes), the node n registers the NOTIFY ID included in the NOTIFY into the redundancy removal table 1100 (S3109). Then, the node n ends the NOTIFY reception process.

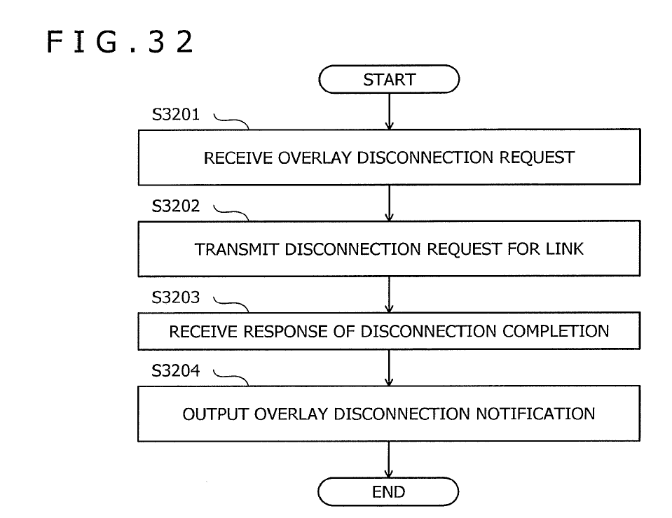

Now, an example of an OVERLAY disconnection process is described with reference to FIG. 32.

FIG. 32 is a flowchart illustrating the OVERLAY disconnection process. Referring to FIG. 32, a node n receives an OVERLAY disconnection request 900 including an address of a node n to be disconnected (S3201). Then, the node n transmits a disconnection request 1700 for a link of the OVERLAY network In to the node n to be disconnected (S3202). Then, the node n receives a response of completion of disconnection (S3203).

Thereafter, the node n outputs an OVERLAY disconnection notification 1800 including the address of the disconnected node n (S3204). Then, the node n ends the OVERLAY disconnection process.

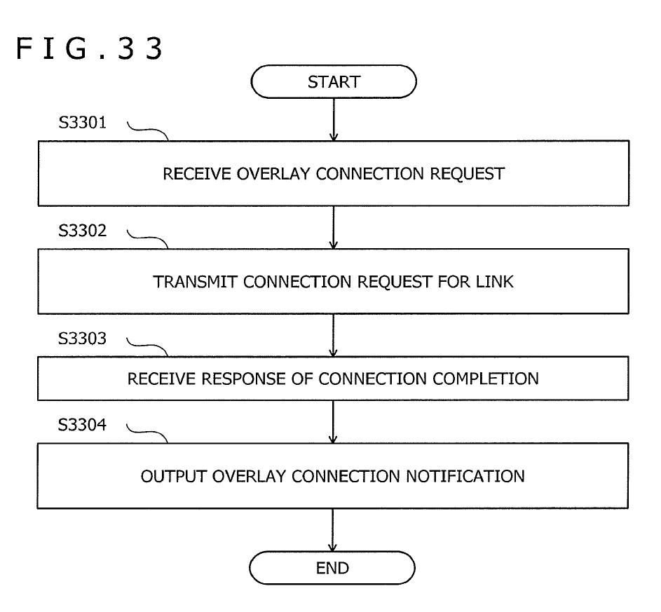

Now, an example of an OVERLAY connection process is described with reference to FIG. 33.

FIG. 33 is a flowchart illustrating the OVERLAY connection process. Referring to FIG. 33, a node n receives an OVERLAY connection request 800 including an address of a node n to be newly connected (S3301). Then, the node n transmits a connection request 1400 for a link of the OVERLAY network In to the node n to be newly connected (S3302). Then, the node n receives a response of completion of connection (S3303).

Thereafter, the node n outputs an OVERLAY connection notification 1500 including the address of the newly connected node n (S3304). Then, the node n ends the OVERLAY connection process.

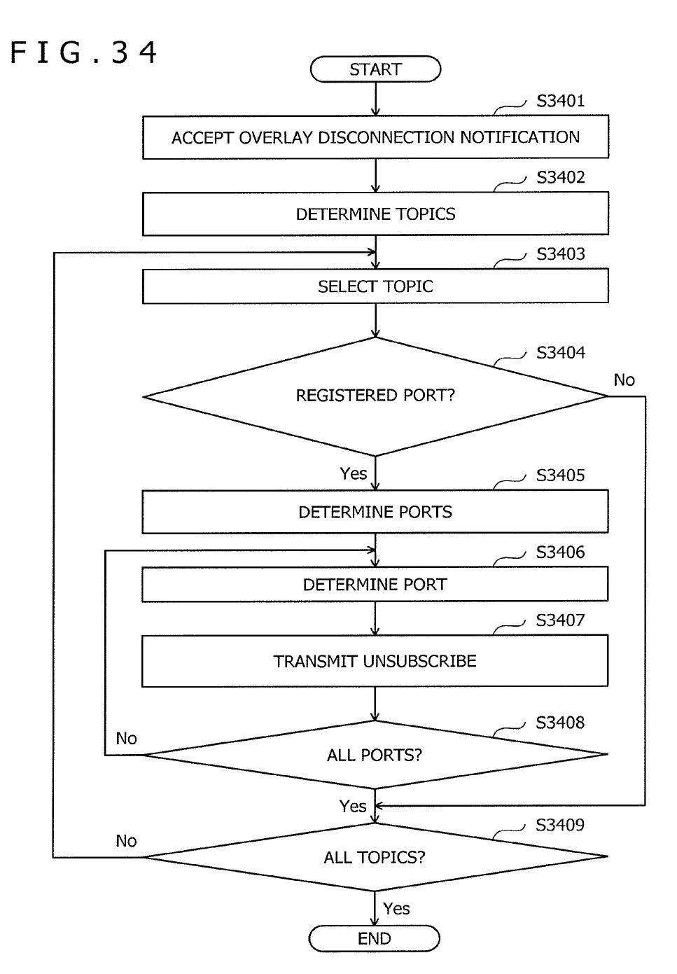

Now, an example of a NOTIFY disconnection process is described with reference to FIG. 34.

FIG. 34 is a flowchart illustrating the NOTIFY disconnection process. Referring to FIG. 34, a node n accepts an OVERLAY disconnection notification 1800 including an address of a node n to be disconnected (S3401). Then, the node n determines topics registered in the Sub/Pub table 1000 in association with ports to the node n to be disconnected (S3402).

Then, the node n selects one of the determined topics (S3403). Then, the node n determines whether or not a port other than the port corresponding to the address of the node n to be disconnected is registered in the Sub/Pub table 1000 in association with the selected topic (S3404). If such port is not registered (S3404: No), the node n advances to S3409.

If such port is registered (S3404: Yes), the node n determines ports other than the port corresponding to the address of the node n to be disconnected (S3405). Then, the node n selects one of the determined ports (S3406). Then, the node n transmits an UNSUBSCRIBE 1900 including the topic and the address of the own node n from the selected port (S3407).

Then, the node n determines whether or not all of the determined ports have been selected (S3408). If there remains a determined port that has not yet been selected (S3408: No), the node n returns to S3406.

If all of the determined ports have been selected (S3408: Yes), the node n determines whether or not all of the determined topics have been selected (S3409). If there remains a determined topic that has not yet been selected (S3409: No), the node n returns to S3403.

If all of the determined topics have been selected (S3409: Yes), the node n ends the NOTIFY disconnection process.

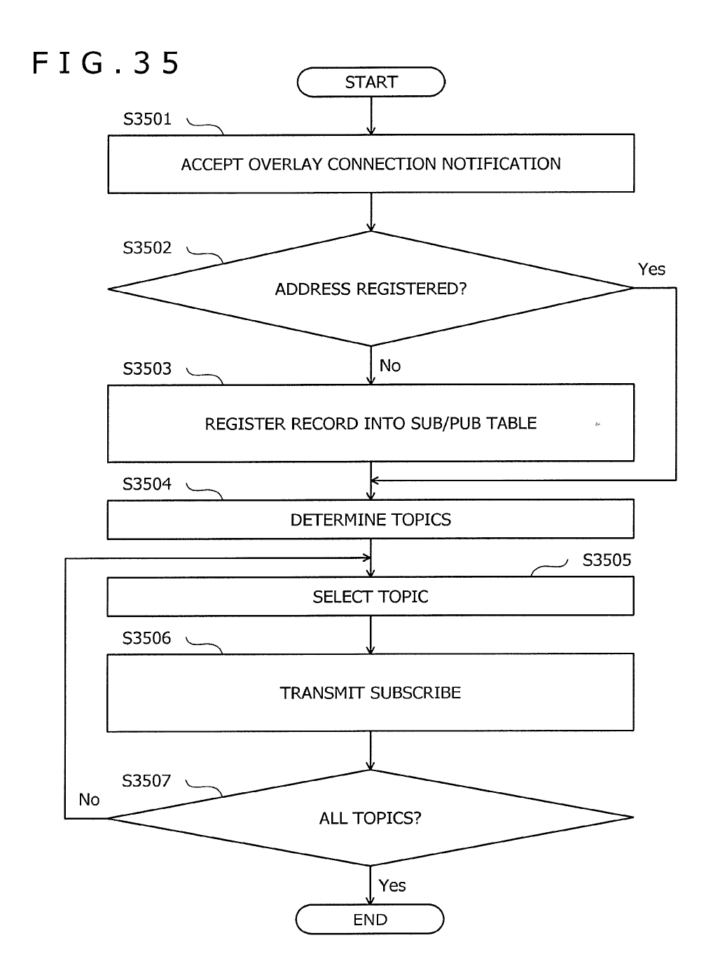

Now, an example of a NOTIFY connection process is described with reference to FIG. 35.

FIG. 35 is a flowchart illustrating the NOTIFY connection process. Referring to FIG. 35, a node n accepts an OVERLAY connection notification 1500 including an address of a newly connected node n (S3501).

Then, the node n determines whether or not the address of the newly connected node n is already registered in the Sub/Pub table 1000 (S3502). If the address is already registered (S3502: Yes), the node n advances to S3504.

If the address is not yet registered (S3502: No), the node n registers a record in which the address of the newly connected node n is associated with the port for the newly connected node n into the Sub/Pub table 1000 (S3503). Then, the node n determines topics registered in the Sub/Pub table 1000 (S3504). Then, the node n selects one of the determined topics (S3505).

Thereafter, the node n transmits a SUBSCRIBE 1600 including the topic and the address of the own node n from the port for the newly connected node n (S3506). Then, the node n determines whether or not all of the determined topics have been selected (S3507). If there remains a determined topic that has not been selected (S3507: No), the node n returns to S3505.

If all of the determined topics have been selected (S3507: Yes), the node n ends the NOTIFY connection process.

As described above, with the route control apparatus 100, whether or not the data transmission route nt is to be changed may be determined based on the traffic volume of a path between each pair of nodes in the data transmission route nt on the OVERLAY network In including a plurality of nodes n. Further, with the route control apparatus 100, when it is determined that the data transmission route nt is to be changed, a pair of nodes to be newly connected to each other and a pair of nodes to be disconnected from each other in the OVERLAY network In may be identified based on the acquired traffic volume of a path between each pair of nodes. Further, with the route control apparatus 100, a TEMPORARY SUBSCRIBE 1300 for adding a temporary path that links the pair of nodes to be newly connected to each other in the OVERLAY network In may be transmitted to the pair of nodes n to be newly connected to each other. Further, with the route control apparatus 100, after the temporary path is added to the data transmission route nt, a change request for changing the connection relationship between each pair of nodes in the OVERLAY network In may be transmitted to the pair of nodes n to be newly connected to each other and the pair of nodes n to be disconnected from each other.

Consequently, even while the connection relationship between each pair of nodes in the OVERLAY network In is being changed, since the temporary path is added to the data transmission route nt, the route control apparatus 100 may keep the data transmission route nt from being disconnected. Therefore, during changing of the connection relationship between each pair of nodes in the OVERLAY network In, the route control apparatus 100 does not allow appearance of a period within which data 1200 does not reach the subscriber s from the publisher p. Further, the route control apparatus 100 may control the nodes n to remove the path, which links the nodes to be disconnected from each other in the OVERLAY network In, from the data transmission route nt in response to the change of the connection relationship between each pair of nodes in the OVERLAY network In. Therefore, the route control apparatus 100 may break a loop in the data transmission route nt and may avoid duplicative pieces of data 1200 having an identical content to be redundantly transmitted through different paths.

Further, with the route control apparatus 100, if a node n to be newly connected redundantly receives duplicative pieces of data 1200 having an identical content through different paths, the route control apparatus 100 may transmit an activation request 700 for activating the redundancy removal process for discarding duplicative pieces of data 1200 while leaving one piece thereof.

Consequently, when the node n redundantly receives duplicative pieces of data 1200 having an identical content, the route control apparatus 100 may discard duplicative pieces of data 1200 while leaving one piece thereof and may keep the duplicative pieces of data 1200 having an identical content from being transferred redundantly from the node n. Therefore, the route control apparatus 100 may avoid increase of the traffic volume of a path between each pair of nodes in the data transmission route nt.

Further, with the route control apparatus 100, a difference may be calculated by subtracting the sum of the traffic volume of a path between each pair of nodes assuming that the data transmission route nt is changed from the sum of the traffic volume of a path between each pair of nodes at present. Further, with the route control apparatus 100, when the calculated difference is equal to or greater than a predetermined threshold value, it may be determined that the data transmission route nt is to be changed.

Consequently, when change of the data transmission route nt decreases the sum of the traffic volume in the overall data transmission route nt and allows data to be transferred efficiently, the route control apparatus 100 may determine that the data transmission route nt is to be changed. Therefore, in such a case that the communication burden on any of the nodes n increases as a result of movement of the publisher p or the subscriber s, the route control apparatus 100 may determine that the data transmission route nt is to be changed if a data transmission route nt that is more preferable than that at present is available.

Further, with the route control apparatus 100, a difference may be calculated by subtracting the sum of the traffic volume of a path between each pair of nodes assuming that the data transmission route nt is changed from an average value of the sum of the traffic volume of a path between each pair of nodes up to the present point of time. Further, with the route control apparatus 100, if the calculated difference is equal to or greater than a threshold value based on a standard deviation of the sum of the traffic volume of a path between each pair of nodes, it may be determined that the data transmission route nt is to be changed.

Consequently, when change of the data transmission route nt decreases the sum of the traffic volume in the overall data transmission route nt and allows data to be transferred efficiently, the route control apparatus 100 may determine that the data transmission route nt is to be changed. Therefore, in such a case that the communication burden on any of the nodes n increases as a result of movement of the publisher p or the subscriber s, the route control apparatus 100 may determine that the data transmission route nt is to be changed if a data transmission route nt that is more preferable than that at present is available. Further, since the route control apparatus 100 uses an average value of the sum of the traffic volume of a path between each pair of nodes up to the present point of time, in such a case that the sum of the traffic volume in the overall data transmission route nt indicates a temporary increase, the route control apparatus 100 may determine that the data transmission route nt is not to be changed. Therefore, the route control apparatus 100 may improve the probability that the data transmission route nt may be placed into a preferable state.

Further, with the route control apparatus 100, if the difference obtained by subtracting the traffic volume of a path between a pair of nodes at a predetermined point of time from the traffic volume of a path between the pair of nodes is equal to or greater than a threshold value, the route control apparatus 100 may determine that the data transmission route nt is to be changed. Consequently, in such a case that the communication burden on any of the nodes n increases as a result of movement of the publisher p or the subscriber s, the route control apparatus 100 may determine that the data transmission route nt is to be changed.

Further, with the route control apparatus 100, a change request may be transmitted such that the connection relationship between each pair of nodes transits, among candidates for the connection relationship between each pair of nodes to which the connection relationship is to transit next, a candidate that indicates a higher reduction degree in the sum of the traffic volume in the OVERLAY network In than the other candidates. Consequently, the route control apparatus 100 may change the connection relationship between each pair of nodes in the OVERLAY network In efficiently.

Further, with the node n, a TEMPORARY SUBSCRIBE 1300 for adding a temporary path from the own node n to another node n to the data transmission route nt on the OVERLAY network In including a plurality of nodes n including the own node n may be accepted. Further, with the node n, a temporary path may be added to the data transmission route nt in response to the acceptance of the TEMPORARY SUBSCRIBE 1300. Further, with the node n, when data 1200 that is to pass another node n is accepted, the data 1200 may be transmitted using the added temporary path.

Consequently, even while the connection relationship between each pair of nodes in the OVERLAY network In is being changed, the node n may transmit the data 1200 to the other node n through the temporary path. Therefore, the node n may avoid appearance of a period within which the data 1200 does not reach the subscriber s from the publisher p.

It is to be noted that the route control method described hereinabove in connection with the present embodiment may be implemented by a computer such as a personal computer or a work station executing a program prepared in advance. A route control program may be recorded into a computer-readable recording medium such as a hard disk, a flexible disk, a compact disc (CD)-ROM, a magneto-optical (MO) disk, or a digital versatile disc (DVD) and is read out from the recording medium and executed by a computer. Alternatively, the route control program may be distributed by a network such as the Internet.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A non-transitory computer-readable recording medium having stored therein a program that causes a computer to execute a process, the process comprising:
acquiring a traffic volume of a path between each pair of nodes in a data transmission route from a plurality of nodes, the data transmission route being formed utilizing a network including the plurality of nodes;
determining on basis of the acquired traffic volume whether the data transmission route is to be changed;
identifying, upon determining that the data transmission route is to be changed, a first pair of nodes and a second pair of nodes on basis of the acquired traffic volume and candidate information, the first pair of nodes being to be newly connected to each other in the network, the second pair of nodes being to be disconnected from each other in the network, the candidate information being indicative of candidates for a pair of nodes to be connected to each other among the plurality of nodes;
transmitting an addition request to at least one node of the first pair of nodes, the addition request requesting to add a first path between the first pair of nodes to the data transmission route; and
removing, after the first path is added, a second path between the second pair of nodes from the data transmission route by transmitting a change request to one node of the first pair of nodes and one node of the second pair of nodes, the change request requesting to change a current connection relationship between each pair of nodes in the network.

2. The non-transitory computer-readable recording medium according to claim 1, the process further comprising:
transmitting a redundancy removal request to at least one node of the first pair of nodes, the redundancy removal request requesting to discard duplicative pieces of data while leaving one piece thereof, the duplicative pieces of data having an identical content and received through different paths

3. The non-transitory computer-readable recording medium according to claim 1, the process further comprising:
calculating a first sum of the acquired traffic volume of a path between each pair of nodes in the data transmission route;
calculating a second sum of a traffic volume of a path between each pair of nodes in a first route assuming that the data transmission route is changed to the first route on basis of the candidate information;
calculating a difference by subtracting the second sum from the first sum; and
determining, when the calculated difference is equal to or greater than a predetermined threshold value, that the data transmission route is to be changed.

4. The non-transitory computer-readable recording medium according to claim 1, the process further comprising:
acquiring the traffic volume of a path between each pair of nodes in the data transmission route from the plurality of nodes at each of a plurality of points of time;
calculating a first sum of the acquired traffic volume of a path between each pair of nodes in the data transmission route at each of the plurality of points of time;
calculating an average value of the first sums;
calculating a second sum of a traffic volume of a path between each pair of nodes in a first route assuming that the data transmission route is changed to the first route on basis of the candidate information;
calculating a difference by subtracting the second sum from the average value; and
determining, when the calculated difference is equal to or greater than a threshold value obtained on basis of a standard deviation of the first sums, that the data transmission route is to be changed.

5. The non-transitory computer-readable recording medium according to claim 1, the process further comprising:
determining, when a difference calculated by subtracting a traffic volume of a third path between a pair of nodes in the data transmission route at a predetermined point of time from the acquired traffic volume of the third path is equal to or greater than a predetermined threshold value, that the data transmission route is to be changed.

6. The non-transitory computer-readable recording medium according to claim 1, the process further comprising:
selecting a first candidate from among a plurality of candidates for connection relationship to which the current connection relationship is to transit next, the first candidate having a higher degree of reduction in a sum of traffic volume of a path between each pair of nodes in the network than the other candidates; and
transmitting the change request to change the current connection relationship to the selected candidate of connection relationship.

7. A route control apparatus, comprising:
a memory; and
a processor coupled to the memory and the processor configured to:
acquire a traffic volume of a path between each pair of nodes in a data transmission route from a plurality of nodes, the data transmission route being formed utilizing a network including the plurality of nodes;
determine on basis of the acquired traffic volume whether the data transmission route is to be changed;
identify, upon determining that the data transmission route is to be changed, a first pair of nodes and a second pair of nodes on basis of the acquired traffic volume and candidate information, the first pair of nodes being to be newly connected to each other in the network, the second pair of nodes being to be disconnected from each other in the network, the candidate information being indicative of candidates for a pair of nodes to be connected to each other among the plurality of nodes;
transmit an addition request to at least one node of the first pair of nodes, the addition request requesting to add a first path between the first pair of nodes to the data transmission route; and
remove, after the first path is added, a second path between the second pair of nodes from the data transmission route by transmitting a change request to one node of the first pair of nodes and one node of the second pair of nodes, the change request requesting to change a current connection relationship between each pair of nodes in the network.

8. A route control method, comprising:
acquiring, by a computer, a traffic volume of a path between each pair of nodes in a data transmission route from a plurality of nodes, the data transmission route being formed utilizing a network including the plurality of nodes;
determining on basis of the acquired traffic volume whether the data transmission route is to be changed;
identifying, upon determining that the data transmission route is to be changed, a first pair of nodes and a second pair of nodes on basis of the acquired traffic volume and candidate information, the first pair of nodes being to be newly connected to each other in the network, the second pair of nodes being to be disconnected from each other in the network, the candidate information being indicative of candidates for a pair of nodes to be connected to each other among the plurality of nodes;
transmitting an addition request to at least one node of the first pair of nodes, the addition request requesting to add a first path between the first pair of nodes to the data transmission route; and
removing, after the first path is added, a second path between the second pair of nodes from the data transmission route by transmitting a change request to one node of the first pair of nodes and one node of the second pair of nodes, the change request requesting to change a current connection relationship between each pair of nodes in the network.
